(19) United States
(12) Patent Application Publication
(10) Pub. No.: US 2019/0269130 A1
(43) Pub. Date: Sep. 5, 2019

(54) DOUBLE SALT IONIC LIQUIDS OF HERBICIDES

(71) Applicant: THE BOARD OF TRUSTEES OF THE UNIVERSITY OF ALABAMA, Tuscaloosa, AL (US)

(72) Inventors: Robin Don Rogers, Tuscaloosa, AL (US); Oana Andreea Cojocaru, Tuscaloosa, AL (US); Gabriela Gurau, Tuscaloosa, AL (US); Julia Shamshina, Northport, AL (US); Juliusz Pernak, Poznan (PL)

(21) Appl. No.: 16/406,477

(22) Filed: May 8, 2019

Related U.S. Application Data
(62) Division of application No. 15/525,413, filed on May 9, 2017, now abandoned.
(60) Provisional application No. 62/078,132, filed on Nov. 11, 2014.

(51) Int. Cl. A01N 37/40; A01N 33/12; A01N 39/04; A01N 57/20

(52) U.S. Cl. CPC A01N 37/40; A01N 57/20; A01N 39/04; A01N 33/12

(57) ABSTRACT

Disclosed are compositions and methods of preparing compositions of active herbicidal ingredients comprising two or more active herbicidal ingredients. Also disclosed are methods of using the compositions described herein to reduce herbicide resistance and minimize off-target movement.

### CROSS REFERENCE TO RELATED APPLICATIONS

This application claims benefit of U.S. Provisional Patent Application No. 62/078,132, filed Nov. 11, 2014, which is hereby incorporated herein by reference in its entirety.

### FIELD

The subject matter disclosed herein generally relates to compositions of herbicidal ingredients where there are two or more herbicidal ingredients in the same composition. Also the subject matter disclosed herein generally relates to methods of making and using herbicidal compositions.

### BACKGROUND

An herbicide is a natural or synthetic chemical substance used to kill unwanted plants. Herbicides can be divided into two categories based on their plant control selectivity: (i) selective or (ii) non-selective.

Selective herbicides kill specific targets while leaving the desired crop relatively unharmed. Some of these herbicides act by interfering with the growth of a weed and are synthetic “imitations” of naturally occurring plant hormones. Some examples of selective herbicides include alkyl derivatives (e.g., dalapon, endothall), phenyl derivatives (e.g., picloram), and phenoxycarboxylic acid derivatives, such as 2,4-dichlorophenoxyacetic acid (2,4-D), 4-(2,4-dichlorophenoxy)butyric acid (2,4-DB), 4-chloro-2-methylphenoxyacetic acid (MCPA), 4-(4-chloro-2-methylphenoxy)butanoic acid (MCPB), 2,4,5-trichlorophenoxyacetic acid (2,4,5-T), 3,6-dichloro-2-methoxy benzoic acid (dicamba), 2-(4-chloro-2-methylphenoxy)propanoic acid (Mecoprop), Mecoprop-P, and 2-(2,4-dichlorophenoxy)propanoic acid (dichlorprop).

Dicamba, also known as 3,6-dichloro-o-anisic acid or 3,6-dichloro-2-methoxy benzoic acid, is a white, crystalline substance with a broad melting point from 114-116° C. Dicamba is both water-soluble (500 mg/dm³) and alcohol soluble (922 g/dm³ ethanol). Dicamba is a selective systemic herbicide belonging to a group of growth regulators, a naturally occurring plant hormone that causes uncontrolled growth in plants. At sufficiently high levels of exposure, the herbicide can accumulate growth areas of the plant, which can result in abnormal growth and plant death. This herbicide is designed to selectively control annual and perennial weeds in fields containing cereals, corn, perennial seed grasses, and sugar cane. It can be applied on lawns, pastures, and other areas of non-agricultural use. Dicamba is most effective on weeds that are in early stages of development. Dicamba can be used as a single active substance (commercial preparations such as dicamba 480 SL or Banvel 480 SL), or in a mixture with other compounds, including, but not limited to, 2,4-D, MCPA, mecoprop, prosulfuron, triasulfuron, and primisulfuron-methyl.

Glyphosate, N-(phosphonomethyl)glycine, an organophosphorous derived herbicide, is an example of a non-selective systemic herbicide, which can be used to kill a broad-spectrum of weeds. It can be applied by a sprayed solution. Glyphosate can be absorbed through the leaves of a plant, applied directly to the stump of a tree, or used in the cut-stump treatment as a forestry herbicide. Glyphosate is the most used herbicide in the USA, where 85-90 million pounds are used annually in US agriculture industry. Glyphosate's mode of action comprises the inhibition of an enzyme involved in the synthesis of the aromatic amino acids tyrosine, tryptophan, and phenylalanine. It can be absorbed through foliage and translocated to growing points. Because of this mode of action, it can be effective on actively growing plants.

Some of the previously mentioned herbicides bind to soil particles, and therefore have the potential to leach from soils into the groundwater supply or nearby water sources. The leaching of the herbicide can increase when higher amounts of herbicide are applied. Additionally, many herbicides are highly water-soluble and can persist in groundwater. Thus, these herbicides can move from the intended target onto non-target crops (i.e., off-target movement) through three methods: (i) drift by physical movement of spray, (ii) volatilization by evaporation of the applied herbicide, and (iii) lateral movement through the groundwater supply. Because of the wide agricultural and environmental importance of the application of herbicides, there is increasing interest in finding derivatives of these herbicides that will maintain or improve the herbicidal properties while eliminating mobility issues and increasing efficacy to minimize overall chemical usage.

For example, dicamba may volatilize from plant surfaces, especially when temperatures are over 30° C., due to their high vapor pressures. Under normal conditions, once vaporized, the herbicide can drift up to 10 miles, which could significantly contaminate and injure off-target vegetation. Many crop production areas can be close to urban environments, which may increase their overall impact. Additionally, the acidic herbicides, such as glyphosate, 2,4-D, and dicamba, can be highly toxic, which can pose significant hazards to a worker's safety. For example, rat LD₅₀ ranges, which are values that can be used to estimate human toxicity, for 2,4-D and dicamba are 639-764 and 1039 mg/kg, respectively.

Minimization of off-target movement of applied herbicides should be achieved to (i) reduce environmental impact, (ii) diminish potential for human contamination including workers, and (iii) lessen the potential economic losses due to movement onto non-desirable crops. Excessive leaching and vaporization can diminish herbicidal efficacy; thus, several forms of these compounds, e.g., chemically modified structures such as emulsified esters, dimethylamine salts, and metal salts, have been developed and used to prolong activity and minimize leaching. In terms of the required dose, the emulsified esters are among the most efficient in controlling harmful undergrowth; however, these derivatives suffer from issues similar to non-modified herbicides, including drifting and volatility. Interestingly, some dimethylamine and methylamine salts can be more efficient; however, upon volatilization of these low boiling amines, the compounds revert to the original neutral, volatile parent herbicide. Potassium and sodium salts are less volatile, but can be highly water-soluble and can persist in ground water. Adjustment of the acidity of herbicidal formulations (i.e., increasing and decreasing the acidity) has also been attempted; however, no effect was observed on movement in the soil. Additionally, increased persistence was observed when the pH increased from 5.3 to 7.5. Use of additives or adjuvants to decrease the mobility of the active herbicide has only been partially successful. Further, due to the presence of acidic groups (such as carboxylic acid groups or phosphoric acid sites) within the molecular structure of the herbicide, it can form metal complexes, which can result in an increase in environmental mobility.

International application No. PCT/US2011/043016 by Pernak et al. described reducing the volatility and drift of the active herbicide while lowering the water solubility of the active herbicide by chemically transforming herbicide active ingredients into ionic liquids, which were defined by Pernak et al. as salts that melt below 150° C. The volatility of the claimed compounds can be negligible in comparison to the original formulations. Furthermore, by selecting an appropriate cation to pair with an anionic version of the herbicide, key properties, such as increased penetration and decrease water solubility could be obtained. U.S. patent application US2008/0207452 by Kramer et al. describes preparing ionic liquids by pairing a single active herbicide anion (2,4-D or dicamba) with a single amine-based cation. The resulting salts were shown to prossess decreased volatility while retaining herbicidal activity.

Additionally, one of the rising challenges is the development herbicide resistant crops, which are crops that have developed a resistance to a particular chemical-based herbicide. Typically, this epidemic has been addressed by either (i) applying the selected herbicide more frequently or in greater quantity, which can lead to even greater environmental risk due to increased volatility, leaching, or drift or (ii) applying more than one herbicide either as a mixture or in consecutive doses.

One strategy to address herbicide resistance in weeds has been to develop formulations derived from the original active ingredients, but with multiple modes of action, such as ROUNDUP′ XTEND by Monsanto Company, which combines glyphosate and dicamba into a single formulation. The synergistic effect of combining glyphosate and dicamba into a single formulation (International Application No. PCT/US2011/034899 by Satchivi and Wright and Spaunhorst et al. Weed Technology 2013, 27:675-681) has been previously explored and could lead to a decrease of herbicide resistance. While these formulations improve the efficacy of weed control, they are simply a mixture of the two precursor solutions. The simple mixture of a solution of glyphosate and a solution dicamba, as previously described, does not address the volatility, drift, and water solubility concerns with the original formulations. Additionally, they can contain a variety of other additives designed to improve performance of the herbicide, such as surfactants to increase transport to the targeted plant. These further contribute to the environmental impact and waste of the herbicide application.

In order to address the issue of herbicide-resistance in weeds while still addressing issues with volatility, drift, and water solubility, the subject matter disclosed herein relates to herbicides that possess multiple herbidical ingredients with low volatilities, drift, and water solubility. Also, disclosed herein are herbicides that can stay on the plant longer, thus reducing repeat applications, decreasing environmental mobility, and increase worker safety. Derivatization of current herbicides as described herein can allow for the cation to be selected, therefore a specific functionality or property can independently and simultaneously be introduced without the need for the subsequent addition of agents to the compositions, such as surfactants, stabilizers, or dyes. Methods of preparing these compositions are also needed and described herein. As such, the compositions and methods described herein meet these and other needs.

### SUMMARY

The present disclosure relates to compositions of herbicidal ionic liquids comprising one or more active herbicide ingredients and methods of making and using such ionic liquids. In some aspects, the herbicidal ionic liquids with multiple active herbicide ingredients can be prepared as separate ionic liquids, each with a single active, and later combined. In some aspects, the herbicidal ionic liquids with multiple active herbicide ingredients can be prepared and isolated as a single composition comprising multiple active herbicide ingredients. In still other aspects, the herbicidal ionic liquids can comprise a single active herbicidal ingredient. The use of single and polymeric cations to prepare herbicidal ionic liquids is also disclosed. Formulations comprising these ionic liquids are also discusses herein. Methods of making and using these ionic liquids are also disclosed.

Additional advantages of the disclosed compositions and methods will be set forth in part in the description which follows, and in part will be obvious from the description. The advantages of the disclosed compositions will be realized and attained by means of the elements and combinations particularly pointed out in the appended claims. It is to be understood that both the foregoing general description and the following detailed description are exemplary and explanatory only and are not restrictive of the disclosed compositions, as claimed.

### BRIEF DESCRIPTION OF THE FIGURE

The accompanying FIGURE, which is incorporated in and constitutes a part of this specification, illustrates several aspects described below.

FIG. 1 displays a schematic illustration of a combination of equimolar amounts of [A][B] and [C][D] versus mixing an equimolar amount of [A][D] and [C][B].

### DETAILED DESCRIPTION

Provided herein are compositions that comprise herbicide active ingredients, including but not limited to dalapon, endothall, phenyl 3,6-dichloro-2-methoxy benzoic acid (dicamba), 4-chloro-2-methylphenoxyacetic acid (MCPA), 2,4-dichlorophenoxyacetic acid (2,4-D), 4-(2,4-dichlorophenoxy)butyric acid (2,4-DB), 4-(4-chloro-2-methylphenoxy)butanoic acid (MCPB), 2,4,5-trichlorophenoxyacetic acid (2,4,5-T), 2-(4-Chloro-2-methylphenoxy)propanoic acid (Mecoprop), 2-(2,4-dichlorophenoxy)propanoic acid (Dichlorprop or 2,4-DP], Mecoprop-P, glyphosate, and fosamine as anions. The herbicidal compositions described herein comprise cations and anions and possess dual functionality in which both the cation and anion contribute different properties, such as herbicidal activity and physical properties to the composition. For example, the disclosed compositions can be designed to improve delivery of the herbicides and introduce additional biological function (e.g., antimicrobial, fungicidal, and other herbicidal) to the herbicides. Penetration enhancers, such as surfactants and fatty acids, can also be introduced into the herbicidal compositions to provide increased penetration into the plant, which could result in increased efficacy.

By combining the anions and cations disclosed herein, an ionic liquid can result. As such, the disclosed compositions in some aspects can be ionic liquids and can be used in that form. However, ionic liquids need not actually be prepared and used. In some aspects, a composition can be dissolved in solution, where the composition can comprise cations and anions capable of forming an ionic liquid. While not wishing to be bound by theory, it is believed that as a result of the ionic liquid forming propensity of the particular cations and anions used herein, the herbicidal compositions described herein can possess reduced volatility and drift, which can lead to increased worker safety and lower water solubility. As a result, the herbicidal compositions can remain on the plant for a longer period, reducing repeat applications and environmental mobility (e.g., through water wash off or volatization into the environment). In addition, the combination of two or more active chemicals in a single composition reduces the number of additional chemicals such as adjuvants or surfactants required per application, and can introduce secondary biological function.

The materials, compounds, compositions, articles, and methods described herein can be understood more readily by reference to the following detailed description of specific aspects of the disclosed subject matter and the Examples included therein.

Before the present materials, compounds, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an ionic liquid” includes mixtures of two or more such ionic liquids, reference to “the compound” includes mixtures of two or more such compounds, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed, then “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, by “plants” is meant terrestrial plants and aquatic plants.

By “reduce” or other forms of the word, such as “reducing” or “reduction,” is meant lowering of an event or characteristic (e.g., plant growth or survival). It is understood that this is typically in relation to some standard or expected value, in other words it is relative, but that it is not always necessary for the standard or relative value to be referred to. For example, “reduces plant growth” means lowering the amount of plant relative to a standard or a control.

By “treat” or other forms of the word, such as “treated” or “treatment,” is meant to administer a composition or to perform a method in order to reduce, prevent, inhibit, break-down, or eliminate a particular characteristic or event (e.g., plant growth or survival). The term “control” is used synonymously with the term “treat.”

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

### Chemical Definitions

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

References in the specification and concluding claims to the molar ratio of a particular element or component in a composition denotes the molar relationship between the element or component and any other elements or components in the composition or article for which a part by weight is expressed. Thus, in a compound containing 2 moles of X and 5 moles of Y, X and Y are present at a molar ratio of 2:5, and are present in such ratio regardless of whether additional components are contained in the compound.

A weight percent (wt. %) of a component, unless specifically stated to the contrary, is based on the total weight of the formulation or composition in which the component is included.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., Zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation acetylation, esterification, deesterification, hydrolysis, etc.

The term “anion” is a type of ion and is included within the meaning of the term “ion.” An “anion” is any molecule, portion of a molecule (e.g., Zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., Zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

“A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

The term “alkyl” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkyl alcohol” is used in another, it is not meant to imply that the term “alkyl” does not also refer to specific terms such as “alkyl alcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “alkoxy” as used herein is an alkyl group bound through a single, terminal ether linkage; that is, an “alkoxy” group can be defined as —OA¹ where A¹ is alkyl as defined above.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “alkynyl” as used herein is a hydrocarbon group of 2 to 24 carbon atoms with a structural formula containing at least one carbon-carbon triple bond. The alkynyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “aryl” as used herein is a group that contains any carbon-based aromatic group including, but not limited to, benzene, naphthalene, phenyl, biphenyl, phenoxybenzene, and the like. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term “non-heteroaryl,” which is also included in the term “aryl,” defines a group that contains an aromatic group that does not contain a heteroatom. The aryl group can be substituted or unsubstituted. The aryl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above, and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

The term “aldehyde” as used herein is represented by the formula —C(O)H. Throughout this specification “C(O)” is a short hand notation for C═O.

The terms “amine” or “amino” as used herein are represented by the formula NA¹A²A³, where A¹, A², and A³ can be, independently, hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “carboxylic acid” as used herein is represented by the formula —C(O)OH. A “carboxylate” as used herein is represented by the formula —C(O)O⁻.

The term “ester” as used herein is represented by the formula —OC(O)A¹ or —C(O)OA¹, where A¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula A¹OA², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “ketone” as used herein is represented by the formula A¹C(O)A², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide” as used herein refers to the halogens fluorine, chlorine, bromine, and iodine.

The term “hydroxyl” as used herein is represented by the formula —OH.

The term “nitro” as used herein is represented by the formula —NO₂.

The term “silyl” as used herein is represented by the formula —SiA¹A²A³, where A¹, A², and A³ can be, independently, hydrogen, alkyl, halogenated alkyl, alkoxy, alkenyl, alkynyl, aryl, heteroaryl, cycloalkyl, cycloalkenyl, heterocycloalkyl, or heterocycloalkenyl group described above.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

As used herein, substantially pure means sufficiently homogeneous to appear free of readily detectable impurities as determined by standard methods of analysis, such as thin layer chromatography (TLC), nuclear magnetic resonance (NMR), gel electrophoresis, high performance liquid chromatography (HPLC) and mass spectrometry (MS), gas-chromatography mass spectrometry (GC-MS), and similar, used by those of skill in the art to assess such purity, or sufficiently pure such that further purification would not detectably alter the physical and chemical properties, such as enzymatic and biological activities, of the substance. Both traditional and modern methods for purification of the compounds to produce substantially chemically pure compounds are known to those of skill in the art. A substantially chemically pure compound may, however, be a mixture of stereoisomers.

The term “bioactive property” is any local or systemic biological, physiological, or therapeutic effect in a biological system. For example, the bioactive property can be the control of fungi, plants, microorganisms, algae, pests like insects, mites, nematodes, rodents, viruses, a plant food, penetration enhancer, etc. Many examples of these and other bioactive properties are disclosed herein.

The term “ionic liquid” describes a salt with a melting point below 150° C., whose melt is composed of discrete ions.

The term “eutectic” is a mixture of two or more ionic liquids, ionic liquids and neutral compounds, ionic liquids and charge compounds, ionic liquids and complexes, ionic liquids and ion pairs, or two or more ion pairs that have at least one component in common.

The term “double salt ionic liquid” describes an ionic liquid, which comprises two or more cations and/or two or more anions within the same composition.

It is understood that throughout this specification the identifiers “first” and “second” are used solely to aid in distinguishing the various components and steps of the disclosed subject matter. The identifiers “first” and “second” and the like are not intended to imply any particular order, amount, preference, or importance to the components or steps modified by these terms.

Reference will now be made in detail to specific aspects of the disclosed materials, compounds, compositions, articles, and methods, examples of which are illustrated in the accompanying Examples.

### Materials and Compositions

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), Sigma (St. Louis, Mo.), or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989). Other materials, such as the active herbicides, and other biological agents disclosed herein can be obtained from commercial sources.

In one aspect, disclosed herein are ionic liquid compositions. The term “ionic liquid” has many definitions in the art, but is used herein to refer to salts (i.e., compositions comprising cations and anions) that are liquid at a temperature of at or below about 150° C., e.g., at or below about 120, 100, 80, 60, 40, or 25° C. That is, at one or more temperature ranges or points at or below about 150° C. the disclosed ionic liquid compositions are liquid; although, it is understood that they can be solids at other temperature ranges or points. Since the disclosed ionic liquid compositions are liquid, and thus not crystalline solids, at a given temperature, the disclosed compositions do not suffer from the problems of polymorphism associated with crystalline solids. An ionic liquid is not considered a mere solution containing ions as solutes dissolved therein.

The use of the term “liquid” to describe the disclosed ionic liquid compositions is meant to describe a generally amorphous, non-crystalline, or semi-crystalline state. For example, while some structured association and packing of cations and anions can occur at the atomic level, the disclosed ionic liquid compositions have minor amounts of such ordered structures and are therefore not crystalline solids. The compositions disclosed herein can be fluid and free-flowing liquids or amorphous solids such as glasses or waxes at a temperature at or below about 150° C. In particular examples disclosed herein, the disclosed ionic liquid compositions are liquid at which the composition is applied (i.e., ambient temperature).

Further, the disclosed ionic liquid compositions are materials composed of at least two different ions; each of which can independently and simultaneously introduce a specific characteristic to the composition not easily obtainable with traditional dissolution and formulation techniques. Thus, by providing different ions and ion combinations, one can change the characteristics or properties of the disclosed ionic liquid compositions in a way not seen by simply preparing various crystalline salt forms. Examples of characteristics that can be controlled in the disclosed compositions include, but are not limited to, melting, solubility control, and rate of dissolution. It is this multi-nature/functionality of the disclosed ionic liquid compositions which allows one to fine-tune or design in very specific desired material properties.

It is further understood that the disclosed ionic liquid compositions can include solvent molecules (e.g., water); however, these solvent molecules should not be present in excess in the sense that the disclosed ionic liquid compositions are dissolved in the solvent, forming a solution. That is, the disclosed ionic liquid compositions contain no or minimal amounts of solvent molecules that are free and not bound or associated with the ions present in the ionic liquid composition. Thus, the disclosed ionic liquid compositions can be liquid hydrates or solvates, but not solutions.

Ionic liquids have been of general interest because they are environmentally-friendly alternatives to organic solvents for various chemical processes, e.g., liquid/liquid extractions, catalysis, separations, and electrochemistry. Ionic liquids have also become popular alternative media for chemical synthesis because of their low volatility and low toxicity. See e.g., Wasserscheid and Keim, Angew Chem Int Ed Engl, 2000, 39:3772; and Wasserscheid, “Ionic Liquids in Synthesis,” 1^{st} Ed., Wiley-VCH, 2002. Further, ionic liquids can reduce costs, disposal requirements, and hazards associated with volatile organic compounds. Other exemplary properties of ionic liquids are high ionic conductivity, non-volatility, non-flammability, high thermal stability, wide temperature for liquid phase, highly solvability, and non-coordinating. For a review of ionic liquids see, for example, Welton, Chem Rev. 1999, 99:2071-2083; and Carlin et al., Advances in Nonaqueous Chemistry, Mamantov et al. Eds., VCH Publishing, New York, 1994.

The specific physical properties (e.g., melting point, viscosity, density, water solubility, etc.) of ionic liquids are determined by the choice of cation and anion, as is disclosed more fully herein. As an example, the melting point for an ionic liquid can be changed by making structural modifications to the ions or by combining different ions. Similarly, the particular chemical properties (e.g., bioactivity, toxicity, pharmacokinetics, etc.), can be selected by changing the constituent ions of the ionic liquid.

The ionic liquid compositions disclosed herein are comprised of at least two kinds of herbicidal active as anions and at least one kind of cation. The at least one kind of cation, can be a fungicidal active, a pesticidal active, another herbicidal active, a plant food, a surfactant, a penetration enhancer, or the like, including any combination thereof, as is disclosed herein. The disclosed ionic liquids can comprise more than one kind of anion (e.g., 2, 3, 4, 5, 6, 7, 8, 9, 10, or more different kinds of herbicidal actives as anions) with one or more than one kind of cation (e.g., 1, 2, 3, 4, 5, 6, 7, 8, 9, 10 or more different kinds of cations). Specific examples include, but are not limited to, one kind of cation with 2, 3, 4, 5, 6, 7, 8, 9, 10, or more kinds of anions, 2 kinds of cations with 2, 3, 4, 5, 6, 7, 8, 9, 10, or more kinds of anions, 3 kinds of cations with 2, 3, 4, 5, 6, 7, 8, 9, 10, or more kinds of anions, 4 kinds of cations with 2, 3, 4, 5, 6, 7, 8, 9, 10, or more kinds of anions, 5 kinds of cations with 2, 3, 4, 5, 6, 7, 8, 9, 10, or more kinds of anions, 6 kinds of cations with 2, 3, 4, 5, 6, 7, 8, 9, 10, or more kinds of anions, 7 kinds of cations with 2, 3, 4, 5, 6, 7, 8, 9, 10, or more kinds of anions, 8 kinds of cations with 2, 3, 4, 5, 6, 7, 8, 9, 10, or more kinds of anions, 9 kinds of cations with 2, 3, 4, 5, 6, 7, 8, 9, 10, or more kinds of anions, 10 kinds of cations with 2, 3, 4, 5, 6, 7, 8, 9, 10, or more kinds of anions, or more than 10 kinds of cations with 2, 3, 4, 5, 6, 7, 8, 9, 10, or more kinds of anions.

In addition to the cations and anions, the ionic liquid compositions disclosed herein can also contain nonionic species, such as solvents, preservatives, dyes, colorants, thickeners, surfactants, viscosity modifiers, mixtures and combinations thereof and the like. However, the amount of such nonionic species is typically low (e.g., less than about 10, 9, 8, 7, 6, 5, 4, 3, 2, or 1 wt. % based on the total weight of the composition). In some examples described herein, the disclosed ionic liquid compositions are neat; that is, the only materials present in the disclosed ionic liquids are the cations and anions that make up the ionic liquid (the salt itself). It is understood, however, that even with neat ionic liquids, some additional materials or impurities can sometimes be present, albeit at low to trace amounts (e.g., less than about 10, 9, 8, 7, 6, 5, 4, 3, 2, or 1 wt. % based on the total weight of the composition).

The disclosed ionic liquids care liquid at some temperature range or point at or below about 150° C. For example, the disclosed ionic liquids can be a liquid at or below about 150, 149, 148, 147, 146, 145, 144, 143, 142, 141, 140, 139, 138, 137, 136, 135, 134, 133, 132, 131, 130, 129, 128, 127, 126, 125, 124, 123, 122, 121, 120, 119, 118, 117, 116, 115, 114, 113, 112, 111, 110, 109, 108, 107, 106, 105, 104, 103, 102, 101, 100, 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1, 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, or −30° C., where any of the stated values can form an upper or lower endpoint when appropriate. In further examples, the disclosed ionic liquids can be liquid at any point from about −30° C. to about 150° C., from about −20° C. to about 140° C., −10° C. to about 130° C., from about 0° C. to about 120° C., from about 10° C. to about 110° C., from about 20° C. to about 100° C., from about 30° C. to about 90° C., from about 40° C. to about 80° C., from about 50° C. to about 70° C., from about −30° C. to about 50° C., from about −30° C. to about 90° C., from about −30° C. to about 110° C., from about −30° C. to about 130° C., from about −30° C. to about 150° C., from about 30° C. to about 90° C., from about 30° C. to about 110° C., from about 30° C. to about 130° C., from about 30° C. to about 150° C., from about 0° C. to about 100° C., from about 0° C. to about 70° C., from about 0° to about 50° C., and the like.

Further, in some examples the disclosed ionic liquid compositions can be liquid over a wide range of temperatures, not just a narrow range of, say, 1-2 degrees. For example, the disclosed ionic liquid compositions can be liquids over a range of at least about 4, 5, 6, 7, 8, 9, 10, or more degrees. In other example, the disclosed ionic liquid compositions can be liquid over at least about a 11, 12, 13, 14, 15, 16, 17, 18, 19, 20, or more degree temperature range. Such temperature ranges can begin and/or end at any of the temperature points disclosed in the preceding paragraph.

In many examples disclosed herein the disclosed ionic liquid compositions are liquid at the temperature at which they will be used or processed (e.g., ambient temperature). In still other examples, the disclosed compositions can be liquid at the temperature at which they are formulated or processed.

It is understood, however, that the disclosed ionic liquid compositions can, though need not, be solubilized, and solutions of the disclosed ionic liquids are contemplated herein. Further, the disclosed ionic liquid compositions can be formulated in an extended or controlled release vehicle, for example, by encapsulating the ionic liquids in microspheres or microcapsules using methods known in the art. Still further, the disclosed ionic liquid compositions can themselves be solvents for other solutes. For example, the disclosed ionic liquids can be used to dissolve a particular nonionic or ionic herbicidal active. These and other formulations of the disclosed ionic liquids are disclosed elsewhere herein.

In some examples, the disclosed ionic liquids are not solutions where ions are dissolved in a solute. In other examples, the disclosed ionic liquid compositions do not contain ionic exchange resins. In still other examples, the disclosed ionic liquids are substantially free of water. By substantially free is meant that water is present at less than about 10, 9, 8, 7, 6, 5, 4, 3, 2, 1, 0.5, 0.25, or 0.1 wt. %, based on the total weight of the composition.

The disclosed ionic liquid compositions can be prepared by methods described herein. Generally, the particular cation(s) and anion(s) used to prepare the disclosed ionic liquids are selected as described herein. Then, with the particular cation(s) and anion(s) in hand, they can be combined, resulting in ionic liquid compositions as disclosed herein. Additionally, the method for the preparation of the disclosed ionic liquid compositions can include the reaction in which two neutral species: an anion precursor (e.g., in the form of an inorganic acid, carboxylic organic acid, non-carboxylic acid, or zwitterion species) and a cation precursor (e.g., inorganic base, organic base, zwitterion species) are combined resulting in ionic liquid compositions as disclosed herein.

Providing ions used to prepare the disclosed ionic liquids depends, in one aspect, on the desired properties of the resulting ionic liquid composition. As described herein, the disclosed ionic liquid compositions can have multiple desired properties, which, at least in part, come from the properties of the cation(s) and/or anion(s) used to prepare the ionic liquid. Thus, to prepare the disclosed ionic liquids, one or more kinds of cations with a desired property(ies) are provided. One or more kinds of herbicidal anions can likewise be provided. Of course, providing a desired anion(s) and cation(s) can be done in any order, depending on the preference and aims of the practitioner. For example, a particular cation(s) can be provided and then a particular anion(s) can be provided. Alternatively, a particular anion(s) can be provided and then a particular cation(s) can be provided. Further, the cation(s) and anion(s) can be provided simultaneously.

As noted, providing a suitable ion can be based on selecting an ion that possesses a property that is desired (e.g., the ion has a property that is desired to be possessed by the resulting ionic liquid). Examples of properties that could be desired in a suitable cation and/or anion (and thus the ionic liquid made therefrom) include, but are not limited to, biological, nutritional, pesticidal, and/or herbicidal activity. Inertness, viscosity modulation, solubility modulation, stability, and toxicity are other properties of a given ion that could be desired and considered. While more specific properties are disclosed elsewhere herein, the disclosed methods and compositions are not limited to any particular combination of properties, as such will depend on the preferences and goals of the practitioner.

Typically, the desired properties of the cation(s) and anion(s) will be different or complimentary to one another. In this way, the resulting ionic liquid can possess multiple desired properties: those properties imparted by the cation(s) and those imparted by the anion(s). In other words, some or all of the ions present in the disclosed ionic liquids can independently and simultaneously introduce a specific functionality or property to the disclosed ionic liquid compositions. It is this multiple functionality characteristic that can allow one to fine-tune or design very specific physical, chemical, and bioactive properties in the disclosed ionic liquid compositions. Additional functionality can be obtained by using the disclosed ionic liquid compositions as solvents to dissolve a solute(s) with another desired property, thus resulting in a solution where the ions of the ionic liquid as well as the solute contribute desired properties to the composition. General and specific examples of various combinations of ions and their associated properties are disclosed herein.

Typically, the desired properties of the cation(s) and herbicidal anion(s) will be different or complimentary to one another. In this way, the resulting compositions can possess multiple desired properties: those properties imparted by the cation(s) and those imparted by the herbicidal anion(s). In other words, some or all of the ions present in the disclosed compositions can independently and simultaneously introduce a specific functionality or property to the disclosed compositions. It is this multiple functionality characteristic that can allow one to fine-tune or design very specific physical, chemical, and bioactive properties in the disclosed herbicidal compositions. Additional functionality can be obtained by using the disclosed herbicidal compositions as solvents to dissolve a solute(s) with another desired property, thus resulting in a solution where the ions of the compositions as well as the solute contribute desired properties to the composition. General and specific examples of various combinations of ions and their associated properties are disclosed herein.

In some particular examples, two or more anions in the disclosed compositions are herbicidal actives, e.g., existing herbicides that are ionic or that can be made ionic. Many herbicides exist naturally or at physiological conditions as an ion, or they can be converted to ions via simple chemical transformations (e.g., alkylation, protonation, deprotonation, etc.). As such, these herbicides can be used to prepare a composition as disclosed herein. Such herbicides can further possess additional pesticidal activity, many of which are described herein. Combining such herbicides with other ions to prepare an ionic liquid, as is disclosed herein, can result in the modification and/or enhancement of the herbicides' properties. Similarly, combining in solution these particular combinations of ions can also result in modification and/or enhancement of the herbicides' properties. For example, a first herbicide ion with a given property can be combined with an oppositely charged second ion with another property to effect the slow or controlled release, slow or controlled delivery, or desired physical properties (stability, solubility, toxicity, melting point, etc.), in the herbicidal formulation. In this way, new herbicide compositions can be created by forming ionic liquids or solutions with functionality crafted into the combination of the ions, as disclosed herein.

As another example, the one or both of the herbicidal anions can be combined with a second ion (e.g., a cation) that has properties complimentary to the first. Examples of this can include, but are not limited to, an ion having herbicidal properties being combined with an ion having antimicrobial properties, an ion having herbicidal properties being combined with an ion having fungicidal properties, or an ion having herbicidal properties being combined with an ion having other pesticidal properties. Ionic liquids or solutions resulting from such combinations could find uses as multi-purposed crop protection agents, for example. Further examples can include two differently charged ions each with similar uses but with different mechanisms of action. Specific examples of such combinations can include, but are not limited to, combinations of ions with selective herbicidal properties or non-selective herbicidal properties.

### Double Salt Ionic Liquids

Double salt ionic liquids are ionic liquids that contain greater than one cation and/or greater than one anion, such as but not limited to an ionic liquid composed of two ammonium cations, a single glyphosate anion, and a single dicamba anion, or ([NH₄]₂[Glyph][Dic]). These salts have unique physical and chemical properties, which are different than ionic liquids of one type of cation and one type of anion comprised of components of the double salt (e.g., [NH₄][Glyph] and [NH₄][Dic]). In double salt ionic liquids, the electrostatic interactions are entirely different from those in each of the two parent ILs. These unique interactions between the ions and their physical, chemical and biological properties are derived from the specific choice and abundance of each type of ion. In the double salt ionic liquids, each ion uniquely interacts with the other ions present, to yield a new compound. This differs from physical mixtures where the components only loosely interact or a eutectic.

Combinations of miscible ILs comprise new compounds that are described herein as “Double Salt Ionic Liquids” (DSILs). DSILs can have distinct identities from the parent ILs, as the “mixing” of two ILs can comprise a chemical reaction. The term DSIL encompasses all ionic systems containing more than one type of cation with a common anion or more than one type of anion with a common cation which are liquid below 150° C. Such systems can be prepared from mixing ILs, from direct reactions, by dissolving solid salts in ILs, etc.

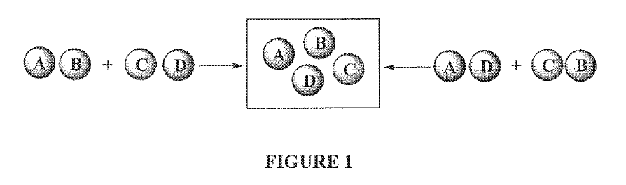

One difference between a DSIL and a mixture is that the identity of the original components in the DSIL is lost. In a mixture of molecular compounds, the molecular structure is preserved. For example, in a solution of a salt dissolved in a molecular solvent, the ratio of ions and ionic bonding are preserved. However, when two or more ILs are mixed, the ratio of the ions can be changed without losing electroneutrality, and all the ions can bond to each other electrostatically regardless of which IL they originated from. This is illustrated by the mixing of two binary ILs with no common ions, where a total of four different ions (two cations: [A]⁺ and [C]⁺; two anions: [B]⁻ and [D]⁻) exist (FIG. 1). These four ions can give rise to four different ILs, i.e., [A][B], [C][D], [A][D], and [C][B]. An equimolar combination of ILs [A][B] and [C][D] gives a substance with an identical composition to the equimolar combination of ILs [A][D] and [C][B]. Dissolving a solid salt in an IL also gives a DSIL by the same reasoning.

Dissolving two solid salts in a molecular solvent is not the same as forming a DSIL. Such solutions can be considered mixtures because the solvent molecules still retain their chemical identities. The salts that are considered to be in solution, however, may not be the same as those that were added to the solvent. If two or more solid salts are dissolved and crystallize in the same proportion in which they were added, then the system is a mixture of those salts in that solvent. If, however, the salts that crystallize are different than the ones that were initially added, the dissolution of the salts can be considered a metathesis reaction giving rise to a mixture. A DSIL dissolved in a molecular solvent is a mixture of the DSIL and the solvent, since the DSIL would be recovered on removal of the solvent.

Mixing or separation of ILs is a chemical, rather than physical, process. In accordance with the law of constant composition, every possible combination of ions in a DSIL gives a compound. This greatly expands the range of compounds which can be formed, as liquids always have a miscibility range and are often fully miscible across every composition.

Suitable ions can be selected based on the above sections to generate unique double salt ionic liquids by modifying the ratios of the ions to generate novel compounds.

### Ions

The disclosed compositions contain at least two herbicidal actives as anions and at least one kind of cation. Examples of suitable anions and cations are disclosed herein. It should be understood that when a particular compound is disclosed as being a cation, for example, it may also, in other circumstances, be an anion and vice versa. Many compounds are known to exist as cations in some environments and anions in other environments. Further, many compounds are known to be convertible to cations and anions through various chemical transformations. Examples of such compounds are disclosed herein.

The materials, compounds, compositions, and components that can be used for, can be used in conjunction with, can be used in preparation for, or are products of the disclosed methods and compositions are disclosed herein. It is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the compositions are discussed, each and every combination and permutation that are possible are specifically contemplated unless specifically indicated to the contrary. Thus, if a class of cations A, B, and C are disclosed as well as a class of anions D, E, and F and an example of a ionic liquid A-D is disclosed, then even if each is not individually recited, each is individually and collectively contemplated. Thus, in this example, each of the ionic liquids A-E, A-F, B-D, B-E, B-F, C-D, C-E, and C-F are specifically contemplated and should be considered disclosed from disclosure of A, B, and C; D, E, and F; and the example ionic liquid A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

### Anions

The herbicidal anions can be anions of dalapon, endothall, phenyl 3,6-dichloro-2-methoxy benzoic acid (Dicamba), 4-chloro-2-methylphenoxyacetic acid (MCPA), 2,4-dichlorophenoxyacetic acid (2,4-D), 4-(2,4-dichlorophenoxy)butyric acid (2,4-DB), 4-(4-chloro-2-methylphenoxy)butanoic acid (MCPB), 2,4,5-trichlorophenoxyacetic acid (2,4,5-T), 2-(4-Chloro-2-methylphenoxy)propanoic acid (Mecoprop), 2-(2,4-dichlorophenoxy)propanoic acid (Dichlorprop or 2,4-DP], Mecoprop-P, N-(phosphonomethyl)glycine (glyphosate), or fosamine, among others. The anions of these herbicides can be formed, for example, by deprotonation of one or more acidic protons of the molecules. Examples of protons that can be deprotonated to form the herbicidal anions include, but are not limited to, those indicated with an asterisk (*) in the structures shown below:

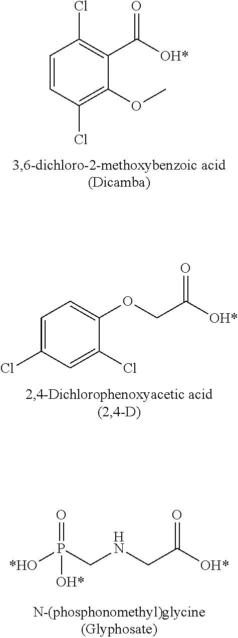

Some examples of suitable herbicides that can be included as a second anion or as a cation include, but are not limited to, carfentrazone, imazapyr, benefin, acifluorfen, and 2-[2-chloro-3-(2,2,2-trifluoroethoxymethyl)-4-methylsulfonylbenzoyl]cyclohexane-1. Other suitable herbicides include inhibitors of the biosynthesis of branched amino acids such as ethoxysulfuron, flumetsulam, halosulfuron, imazamox, imazapyr, imazaquin, imazethapyr, metosulam, nicosulfuron, primisulfuron, prosulfuron, rimsulfuron, thifensulfuron-methyl, triflusulfuron, N-[(4.6-dimethoxypyrimidin-2-yl)aminocarbonyl]-2-dimethylaminocarbonyl-5-formylaminobenzenesulfonamide (Foramsulfuron), and the like. Other suitable herbicides include inhibitors of the photosynthesis electron transport such as ametryne, atrazine, bromoxynil, cyanazine, diuron, hexazinone, metribuzin, pyridate, terbuthylazine, and the like. In other examples, suitable herbicides for the disclosed compositions include synthetic auxins such as copyralid, dicamba, diflufenzopyr, fluroxypyr, and the like. Inhibitors of fatty acid biosynthesis, such as butylate, EPTC, fenoxaprop-P-ethyl, and the like, can also be used in the disclosed ionic liquid compositions. In other examples, suitable herbicides can include inhibitors of cell division such as acetochlor, alachlor, dimethenamid, flufenacet, mefenacet, metolachlor, S-metolachlor, thenylchlor, and the like. In still other examples, the herbicide can be an inhibitor of protoporphyrinogen oxidase, such as fluthiacet-methyl, carfentrazone-ethyl, and the like. Inhibitors of hydroxyphenylpyruvate dioxygenase, such as isoxaflutole, mesotrione, sulcotrione, 4-(4-trifluoromethyl-2-methylsulfonylbenzoyl)-5-hydroxy-1-methyl-3-methylpyrazole, and the like, can also be used. Other examples of suitable herbicides include, but are not limited to, pendimethalin, trifluralin, asulam, triaziflam, diflufenican, glufosinate-ammonium, and the like. Clofencet, fluroxpyr, mesosulfuron, diflufenzopyr are additional examples of suitable herbicides. The structures of selected examples are shown below.

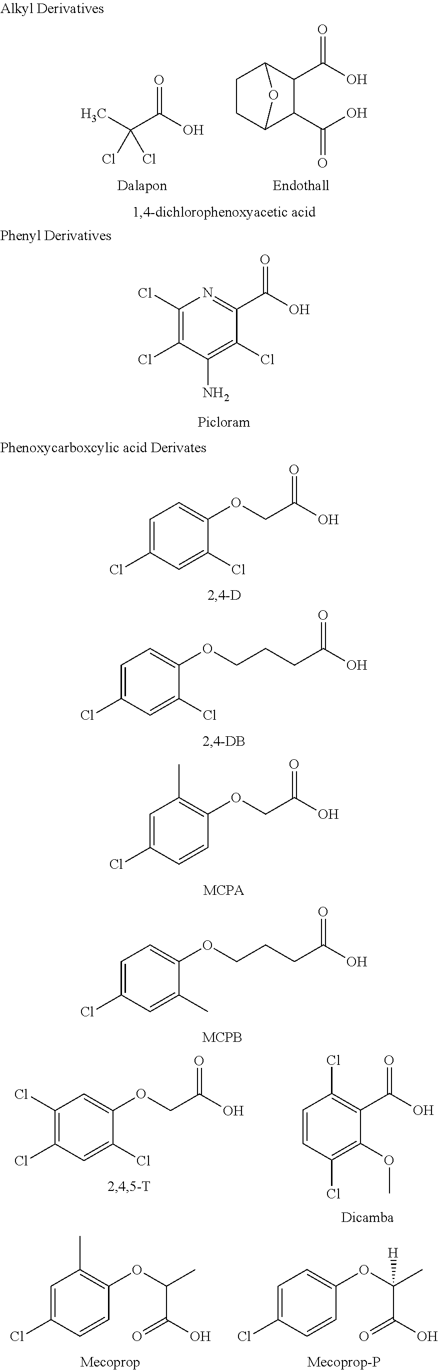

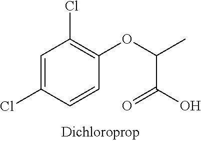

The compositions disclosed herein comprise multiple active herbicide ingredients within the same ionic liquid (double salt). This strategy can be utilized to minimize herbicide-resistance while still providing the improved properties of herbicidal ionic liquids with a single active ingredient, such as decreased volatility, controlled solubility, and improved plant membrane penetration if the correct counter ion is selected as disclosed herein.

In some cases, multiple anions can be incorporated into the same ionic liquid in a molar ratio. For example, if a singly charged cation is selected, glyphosate and dicamba can be the selected anions in a 1 to 1 ratio, which would give an ionic liquid with the following formula: [Cation][Glyph]_{0.5}[Dic]_{0.5}. This can indicate that half of the anions can be comprised of glyphosate and half of the anions can be comprised of dicamba. A greater number of different anions could be paired with a properly selected cation, such as a 1 to 1 to 2 ratio of glyphosate to dicamba to 2,4-D (i.e., [Cation][Glyph]_{0.25}[Dic]_{0.25}[2,4-D]_{0.5}). Some examples are shown in Table 1.

In some cases, multiple anions can be incorporated into the same ionic liquid in a mass ratio. For example, if a polymeric cation is selected, glyphosate and dicamba can be added in a 4.8 to 1 ratio to yield a composition comprising glyphosate and dicamba, such as p-[DADMA][Glyph][Dic] (4.8:1 mass ratio). Some examples are shown in Table 1.

TABLE 1
Double Salt Ionic Liquids Containing Herbicidal Active Ingredients

| | | Molar ratio of | Mass ratio of |
|---|---|---|---|
| | | ions | components |
| Class | Formula | (mol:mol:mol) | (g:g:g) |
| Cholinium 2-[(phosphonomethyl)amino]acetate- | [Cho][HGlyph]_{0.10}[Dic]_{0.90} | 10:1:9 | 104:17:198 |
| 3,6-dichloro-2-methoxy-benzoate | [Cho][HGlyph]_{0.40}[Dic]_{0.60} | 5:2:3 | 520:336:660 |
| | [Cho][HGlyph]_{0.50}[Dic]_{0.50} | 2:1:1 | 208:168:220 |
| | [Cho][HGlyph]_{0.80}[Dic]_{0.20} | 5:4:1 | 520:672:220 |
| | [Cho][Glyph]_{0.33}[Dic]_{0.33} | 3:1:1 | 312:167:220 |
| Tetrabutylammonium | [N_{4,4,4,4}][HGlyph]_{0.36}[Dic]_{0.64} | 10:1:9 | 242:17:198 |
| 2-[(phosphonomethyl)amino]acetate-3,6- | [N_{4,4,4,4}][Glyph]_{0.33} [Dic]_{0.33} | 3:1:1 | 726:167:220 |
| dichloro-2-methoxy-benzoate | | | |
| Tetrabutylphosphonium | [P_{4,4,4,4}][Glyph]_{0.20} [Dic]_{0.60} | 5:1:3 | 1295:167:660 |
| 2-[(phosphonomethyl)amino]acetate-3,6- | [P_{4,4,4,4}][Glyph]_{0.33} [Dic]_{0.33} | 3:1:1 | 777:167:220 |
| dichloro-2-methoxy-benzoate | [P_{4,4,4,4}][Glyph]_{0.30}[Dic]_{0.40} | 10:3:4 | 2590:501:880 |
| | [P_{4,4,4,4}][Glyph]_{0.37}[Dic]_{0.25} | 12:4:3 | 3108:668:660 |
| | [P_{4,4,4,4}][Glyph]_{0.43}[Dic]_{0.14} | 100:43:14 | 259:72:3 |
| Benzalkonium* | [BA][HGlyph]_{0.80}[Dic]_{0.20} | 5:4:1 | 389:668:220 |
| 2-[(phosphonomethyl)amino]acetate-3,6- | [BA][HGlyph]_{0.60}[Dic]_{0.40} | 5:3:2 | 389:501 |
| dichloro-2-methoxy-benzoate | [BA][HGlyph]_{0.50}[Dic]_{0.50} | 2:1:1 | 389:167:440 |
| | [BA][HGlyph]_{0.40}[Dic]_{0.60} | 5:2:3 | 389:334 |
| | [BA][HGlyph]_{0.20}[Dic]_{0.80} | 5:1:4 | 389:167:660 |
| Trihexyltetradecylphosphonium | [P_{6,6,6,14}][Glyph]_{0.40}[Glyph]_{0.20} | 5:2:1 | 2420:334:220 |
| 2-[(phosphonomethyl)amino]acetate-3,6- | [P_{6,6,6,14}][Glyph]_{0.25}[Glyph]_{0.50} | 4:1:2 | 1936:167:440 |
| dichloro-2-methoxy-benzoate | [P_{6,6,6,14}][Glyph]_{0.13}[Glyph]_{0.74} | 100:13:74 | 484:22:163 |

*Average molecular weight of benxylalkonium = 389.

### Cations

Particular examples of cationic compounds that can be present in the disclosed compositions are compounds that contain nitrogen or phosphorus atoms. Nitrogen atom-containing groups can exist as a neutral compound or can be converted to positively-charged quaternary ammonium species, for example, through alkylation or protonation of the nitrogen atom. Thus, compounds that possess a quaternary nitrogen atom (known as quaternary ammonium compounds (QACs)) are typically cations. According to the methods and compositions disclosed herein, any compound that contains a quaternary nitrogen atom or a nitrogen atom that can be converted into a quaternary nitrogen atom can be a suitable cation for the disclosed compositions.

In some examples, phosphorous atoms can exist as a charged phosphonium species, for example, through alkylation of the phosphorous atom. Thus, compounds that possess a quaternary phosphorous atom (known as quaternary phosphonium compounds) are typically cations. According to the methods and compositions disclosed herein, any compound that contains a quaternary phosphorus atom or a phosphorus atom that can be converted into a quaternary phosphonium atom can be a suitable cation for the disclosed compositions.

Any combination of cations can be made as long as the combination would result in an ionic liquid as described herein. Thus, in some examples, the compositions can have at least one type of cation and at least two types of herbicidal anions A and B (in molar ratio of 0.05 to 0.95; 0.1 to 0.9; 0.15 to 0.85; 0.2 to 0.8; 0.25 to 0.75; 0.3 to 0.7; 0.35 to 0.65; 0.4 to 0.6; 0.45 to 0.55; 0.5 to 0.5; 0.55 to 0.45; 0.6 to 0.4; 0.65 to 0.35; 0.7 to 0.3; 0.75 to 0.35; 0.8 to 0.2; 0.85 to 0.15; 0.9 to 0.1; 0.05 to 0.95 and anything in-between), so that the net charge of the ionic liquid is zero.

When the disclosed compositions have two or more ions with a bioactive property (e.g., herbicidal actives, fungicidal actives, antimicrobials, and the like), these compositions can be particularly desired because each of the active ingredients in the composition would have the same solubility and would dissolve together when formulated or administered.

As described above, the herbicidal compositions can be prepared from the two herbicidal anions described above.

Aliphatic Heteroaryls

Some specific QACs suitable for use herein are aliphatic heteroaryls. An aliphatic heteroaryl cation is a compound that comprises at least one aliphatic moiety bonded to a heteroaryl moiety. In the aliphatic heteroaryl cation, the aliphatic moiety can be any alkyl, alkenyl, alkynyl, heteroalkyl, heteroalkenyl, heteroalkynyl, cycloalkyl, cycloalkenyl, heterocycloalkyl, or heterocycloalkenyl group, as described herein. For example, the aliphatic moiety can include substituted or unsubstituted C₁₋₂₀ alkyl, substituted or unsubstituted C₂₋₂₀ alkenyl, substituted or unsubstituted C₂₋₂₀ alkynyl, substituted or unsubstituted C₁₋₂₀ heteroalkyl substituted or unsubstituted C₂₋₂₀ heteroalkenyl, or substituted or unsubstituted C₂₋₂₀ heteroalkynyl groups. Generally, the aliphatic moiety can comprise at least 10, at least 12, at least 14, at least 16, at least 18, or at least 20 carbon atoms. In other examples, the aliphatic moiety can comprise a mixture of aliphatic groups having a range of carbon atoms. For example, the aliphatic moiety can comprise from 10 to 40, from 12 to 38, from 14 to 36, from 16 to 34, from 18 to 32, from 14 to 18, or from 20 to 30 carbon atoms. In some specific examples, the aliphatic moiety can contain 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or 45 carbon atoms, where any of the stated values can form an upper or lower endpoint when appropriate. Examples of specific aliphatic moieties that can be used include, but are not limited to, decyl, dodecyl (lauryl), tetradecyl (myristyl), hexadecyl (palmityl or cetyl), octadecyl (stearyl), eicosyl (arachidyl), and linolenyl groups, including branched derivatives thereof and any mixtures thereof. For example, the aliphatic moieties can include coco, tallow, hydrogenated tallow, oleyl, or soya groups. The aliphatic moieties can further include alkoxymethyl groups (e.g., containing from 2 to 19 carbon atoms) or cycloalkoxymethyl groups (e.g., containing from 5 to 13 carbon atoms). In the aliphatic heteroaryl cations, the aliphatic moiety is bonded to a heteroatom in the heteroaryl moiety.

In the aliphatic heteroaryl cation, the heteroaryl moiety can be any heteroaryl moiety as described herein. For example, the heteroaryl moiety can be an aryl group having one or more heteroatoms (e.g., nitrogen, oxygen, sulfur, phosphorous, or halonium). Examples of specific heteroaryl moieties that can be used in the aliphatic heteroaryl cations include, but are not limited to, substituted or unsubstituted pyrazoles, substituted or unsubstituted pyridines, substituted or unsubstituted pyrazines, substituted or unsubstituted pyrimidines, substituted or unsubstituted pryidazines, substituted or unsubstituted indolizines, substituted or unsubstituted isoindoles, substituted or unsubstituted indoles, substituted or unsubstituted indazoles, substituted or unsubstituted imidazoles, substituted or unsubstituted oxazoles, substituted or unsubstituted triazoles, substituted or unsubstituted thiazoles, substituted or unsubstituted purines, substituted or unsubstituted isoquinolines, substituted or unsubstituted quinolines, substituted or unsubstituted phthalazines, substituted or unsubstituted quinooxalines, substituted or unsubstituted phenazine, substituted or unsubstituted morpholiniums, and the like, including derivatives and mixtures thereof. In the aliphatic heteroaryl cations, a heteroatom in the heteroaryl moiety is bonded to the aliphatic moiety. When the heteroatom of the heteroaryl is nitrogen, this forms a quaternary ammonium cation, as described herein.

Further examples of aliphatic heteroaryl cations include substituted or unsubstituted benztriazoliums, substituted or unsubstituted benzimidazoliums, substituted or unsubstituted benzothiazoliums, substituted or unsubstituted pyridiniums, substituted or unsubstituted pyridaziniums, substituted or unsubstituted pyrimidiniums, substituted or unsubstituted pyraziniums, substituted or unsubstituted imidazoliums, substituted or unsubstituted pyrazoliums, substituted or unsubstituted oxazoliums, substituted or unsubstituted 1,2,3-triazoliums, substituted or unsubstituted 1,2,4-triazoliums, substituted or unsubstituted thiazoliums, substituted or unsubstituted piperidiniums, substituted or unsubstituted pyrrolidiniums, substituted or unsubstituted quinoliums, and substituted or unsubstituted isoquinoliums.

Ammonium (NR¹R²R³R⁴)

The disclosed compositions can also comprise an ammonium cation of the structure NR¹R²R³R⁴ wherein R¹, R², R³, and R⁴ are each independently selected from hydrogen, substituted or unsubstituted C₁₋₂₀ alkyl, substituted or unsubstituted C₂₋₂₀ alkenyl, substituted or unsubstituted C₂₋₂₀ alkynyl, substituted or unsubstituted aryl, substituted or unsubstituted C₁₋₂₀ heteroalkyl, substituted or unsubstituted C₂₋₂₀ heteroalkenyl, substituted or unsubstituted C₂₋₂₀ heteroalkynyl, substituted or unsubstituted heteroaryl, or substituted or unsubstituted carbonyl.

In some examples, the ammonium cation can comprise NR¹R²R³R⁴, wherein R¹ and R² are independently selected from substituted or unsubstituted C₁₋₂₀ alkyl, and R³ and R⁴ are independently selected from substituted or unsubstituted C₂₋₂₀ alkenyl. In some examples, the ammonium cation can comprise diallyldimethyl ammonium, di-dodecyl dimethyl ammonium, di-tetradecyl dimethyl ammonium, dihexadecyl dimethyl ammonium, and the like, including combinations thereof.

Examples of ammonium cations include, but are not limited to, tetraalkyl ammonium cations, alkoxyalkyl ammonium cations, and benzalkyl ammonium cations.

Some specific examples of ammonium cations include, but are not limited to, didecyldimethylammonium, benzalkonium, hexadecyltrimethylammonium, diallyldimethylammonium, trioctylmethylammonium, cocoalkyltrimethylammonium, dicocoalkyldimethylammonium, cocoalkyldi-(2-hydroxyethyl)methylammonium, dodecyldimethylphenoxyethylammonium, tallowalkyldipolyoxyethylene(15)-methylammonium, cocoalkyltrimethylammonium, di(hydrogenated tallow)dimethylammonium, soyatrimethylammonium, cocotrimethylammonium, dicocoalkyldimethylammonium, myristyltrimethylammonium, dioctadecyldimethylammonium, didodecyldimethylammonium, (2-hydroxyethyl)trimethylammonium, (2-chloroethyl)trimethylammonium, didecyldimethylammonium, di(hydrogenated tallow) dimethylammonium, (hydrogenated tallow)trimethylammonium, diallyldimethylammonium, choline, cetyl trimethyl ammonium, lauryl trimethyl ammonium, myristyl trimethyl ammonium, stearyl trimethyl ammonium, arachidyl trimethyl ammonium, cetyl dimethylethyl ammonium, lauryl dimethylethyl ammonium, myristyl dimethylethyl ammonium, stearyl dimethylethyl ammonium, arachidyl dimethylethyl ammonium, or mixtures thereof.

Tetraalkyl Ammonium

The disclosed compositions can also comprise a tetraalkyl ammonium cation of the structure NR¹R²R³R⁴, wherein R¹, R², R³, and R⁴ are each independently selected from substituted or unsubstituted C₁₋₂₀ alkyl. In some examples, R¹, R², R³ and R⁴ (e.g. R¹-R⁴) can comprise alkyl moieties of equivalent length, such as in tetrabutylammonium. In some examples, R¹-R⁴ can comprise two pairs of alkyl moieties, such as in dimethyldibutyl ammonium. In some examples, three of R¹-R⁴ can comprise alkyl moeities of equivalent length, such as in trihexyltetradecylammonium.

In one example, a tetraalkylammonium cation can comprise one long chain alkyl moiety (e.g., 10 or more carbon atoms in length) and three short chain alkyl moieties (e.g., less than 10 carbon atoms in length), such as trihexyltetradecylammonium.

Alkoxyalkyl Ammonium

The disclosed compositions can also comprise a alkoxyalkyl ammonium cation of the structure NR¹R²R³R⁴, wherein R¹, R², R³, and R⁴ are each independently selected from substituted or unsubstituted C₁₋₂₀ alkyl, wherein at least one of R², R³, and R⁴ is substituted with an alkoxy group. In some examples, at least one of R¹-R⁴ can comprise ethoxylmethyl.

Benzylalkyl Ammonium

The disclosed compositions can also comprise a benzylalkyl ammonium cation of the structure NR¹R²R³R⁴, wherein R¹, R², R³, are each independently selected from hydrogen, substituted or unsubstituted C₁₋₂₀ alkyl, substituted or unsubstituted C₂₋₂₀ alkenyl, substituted or unsubstituted C₂₋₂₀ alkynyl, substituted or unsubstituted aryl, substituted or unsubstituted C₁₋₂₀ heteroalkyl, substituted or unsubstituted C₂₋₂₀ heteroalkenyl, substituted or unsubstituted C₂₋₂₀ heteroalkynyl, substituted or unsubstituted heteroaryl, or substituted or unsubstituted carbonyl, and wherein R⁴ comprises a benzyl group. Examples of benzylalkyl ammonium cations include, but are not limited to, alkyl dimethyl benzyl ammonium cations (such as cetyl dimethyl benzyl ammonium, lauryl dimethyl benzyl ammonium, myristyl dimethyl benzyl ammonium, stearyl dimethyl benzyl ammonium, and arachidyl dimethyl benzyl ammonium), and alkyl methylethyl benzyl ammonium cations (such as cetyl methylethyl benzyl ammonium, lauryl methylethyl benzyl ammonium, myristyl methylethyl benzyl ammonium, stearyl methylethyl benzyl ammonium, and arachidyl methylethyl benzyl ammonium).

In some examples, the benzalkyl ammonium cation can comprise a mixture of molecules with varying lengths of alkyl groups. In some examples, the average molecular weight of the benzalkyl ammonium cation can be from 100 g/mol to 1,000 g/mol.

Phosphonium (PR¹R²R³R⁴)

The disclosed compositions can also comprise a phosphonium cation of the structure PR¹R²R³R⁴, wherein R¹, R², R³, and R⁴ are each independently selected from hydrogen, substituted or unsubstituted C₁₋₂₀ alkyl, substituted or unsubstituted C₂₋₂₀ alkenyl, substituted or unsubstituted C₂₋₂₀ alkynyl, substituted or unsubstituted aryl, substituted or unsubstituted C₁₋₂₀ heteroalkyl, substituted or unsubstituted C₂₋₂₀ heteroalkenyl, substituted or unsubstituted C₂₋₂₀ heteroalkynyl, substituted or unsubstituted heteroaryl, or substituted or unsubstituted carbonyl.

In some examples, the phosphonium cation can comprise PR¹R²R³R⁴, wherein R¹ and R² are independently selected from substituted or unsubstituted C₁₋₂₀ alkyl, and R³ and R⁴ are independently selected from substituted or unsubstituted C₂₋₂₀ alkenyl. In some examples, the phosphonium cation can comprise diallyldimethyl phosphonium, di-dodecyl dimethyl phosphonium, di-tetradecyl dimethyl phosphonium, dihexadecyl dimethyl phosphonium, and the like, including combinations thereof.

Examples of ammonium cations include, but are not limited to, tetraalkyl phosphonium cations, alkoxyalkyl phosphonium cations, and benzalkyl phosphonium cations.

Some specific examples of phosphonium cations include, but are not limited to, didecyldimethylphosphonium, hexadecyltrimethylphoshonium, diallyldimethylphoshonium, trioctylmethylphoshonium, cocoalkyltrimethylphosphonium, dicocoalkyldimethylphosphonium, cocoalkyldi-(2-hydroxyethyl)methylphosphonium, dodecyldimethylphenoxyethylphosphonium, tallowalkyldipolyoxyethylene(15)-methylphosphonium, cocoalkyldi-(2-hydroxyethyl)methylphosphonium, di(hydrogenated tallow)dimethylphosphonium, soyatrimethylphosphonium, cocotrimethylphosphonium, dicocoalkyldimethylphosphonium, myristyltrimethylphosphonium, dioctadecyldimethylphosphonium, didodecyldimethylphosphonium, (2-hydroxyethyl)trimethylphosphonium, (2-chloroethyl)trimethylphosphonium, didecyldimethylphosphonium, di(hydrogenated tallow) dimethylphosphonium, (hydrogenated tallow)trimethylphosphonium, diallyldimethylphosphonium, cetyl trimethyl phosphonium, lauryl trimethyl phosphonium, myristyl trimethyl phosphonium, stearyl trimethyl phosphonium, arachidyl trimethyl phosphonium, cetyl dimethylethyl phosphonium, lauryl dimethylethyl phosphonium, myristyl dimethylethyl phosphonium, stearyl dimethylethyl phosphonium, arachidyl dimethylethyl phosphonium, or mixtures thereof.

Tetraalkylphosphonium

The disclosed compositions can also comprise a tetraalkyl phosphonium cation of the structure PR¹R²R³R⁴, wherein R¹, R², R³, and R⁴ are each independently selected from substituted or unsubstituted C₁₋₂₀ alkyl.

In some examples, a tetraalkylphosonium cation can comprise four short chain alkyl moieties (e.g., 10 or less carbon atoms in length), such as tetrabutylphoshonium. In some examples, a tetraalkylphosphonim caiton can comprise other lengths of alkyl chains, such as a mixture of two short chain alkyl moieties (e.g., 10 or less carbon atoms in length) and two long chain alkyl moieties (e.g., 10 or more carbon atoms in length).

In another example, a tetraalkylphosphonium cation can comprise one long chain alkyl moiety (e.g., 10 or more carbon atoms in length) and three short chain alkyl moieties (e.g., less than 10 carbon atoms in length), such as trihexyltetradecylphosphonium.

Alkoxyalkyl Phosphonium

The disclosed compositions can also comprise an alkoxyalkyl phosphonium cation of the structure PR¹R²R³R⁴, wherein R¹, R², R³, and R⁴ are each independently selected from substituted or unsubstituted C₁₋₂₀ alkyl, wherein at least one of R¹, R², R³, and R⁴ is substituted with an alkoxy group. In some examples, at least one of R¹-R⁴ can comprise ethoxylmethyl.

Polymeric Cations

The disclosed compositions can also comprise a cation based on a polymer with a repeating positive charge. Suitable polymeric cations comprise a repeating charged monomer, which can range from a single repetition to over ten thousand repetitions resulting in a molecular weight of up to 1,000,000 g/mol. The charged monomer can comprise any of the previously disclosed classes of cations, such as, but not limited to, a tetraalkylammonium, tetraalkylphosphonium, or aliphatic heteroaryls. For example, the repeating monomer can be diallyldimethylammonium, which results in the poly(diallyldimethylammonium) polymeric cation to pair with multiple herbicide active ingredients.

Examples of suitable monomers can be as seen below.

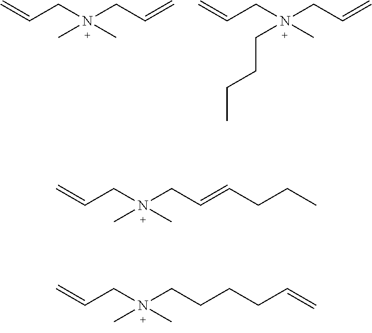

Some of the possible corresponding polymers are shown below.

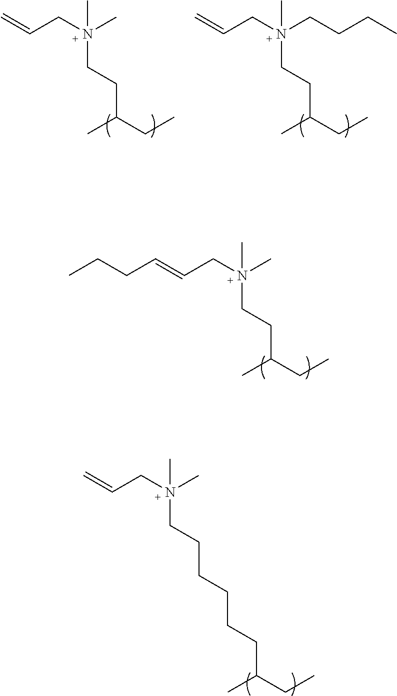

In some examples, the polymers utilized can be based on vinyl monomers, such as, but not limited to N-vinyl pyrrolidone or N-vinylimidazole. The vinyl monomers can be optionally substituted though an alkylation at the corresponding heteroatom to generate a charged species.

In other examples the polymer can be amphiphilic comprising surface active vinyl monomers with alkyl chains of 8 or greater carbon atoms.

In some examples, the monomers that comprise the polymers can be based on acrylic acid, methylacrylic acid, acrylamide, or methylacrylamine. The monomer can be further functionalized with the functional groups described previously, including, but not limited to 2-(Dimethylamino)ethyl methacrylate (DMAEMA) or N,N,N-trimethyl-3-((2-methyl-1-oxo-2-propenyl)amino)-1-propanaminium halides. Some attached functional groups possible include, but are not limited to aliphatic, alkyl, alkenyl, aryl, phenyl,

Other suitable polymers include, but are not limited to polyquat 7, polyquat 28, polyquat ampo 140, polyquat ampho 149, or Merquat S.

### Methods for Preparing the Compositions

The disclosed ionic liquid and double salt ionic liquid compositions can be prepared by methods described herein. For example, (i) herbicidal ionic liquids can be prepared with a polymeric cation and one anion, (ii) double salt herbicidal ionic liquids can be prepared with a polymeric cation and two or more anions, and (iii) double salt herbicidal ionic liquids can be prepared with a cation and two or more anions. These salts can be synthesized though the methods described below. Such methods include, but are not limited to (a) acid-base reaction, (b) salt metathesis, (c) mixing of two ionic liquids, or a combination thereof as described further below.

There are generally three methods for preparing an ionic liquid as described herein: (1) acid-base reaction between the commercial cation hydroxides and dicamba and glyphosate free acids (Scheme 1), (2) metathesis reaction followed by acid-base reaction (Scheme 2), (3) mixing the dicamba and glyphosate based herbicidal ionic liquids in the appropriate molar ratio.

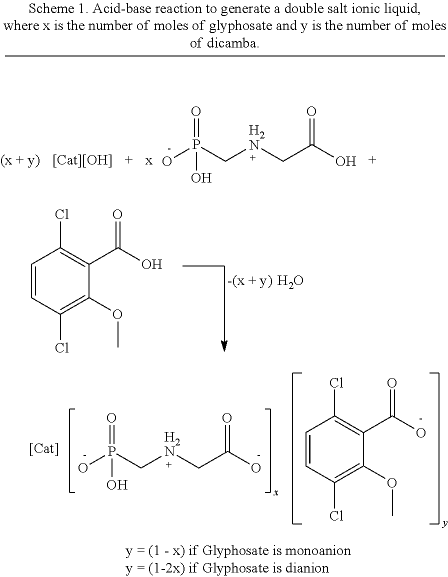

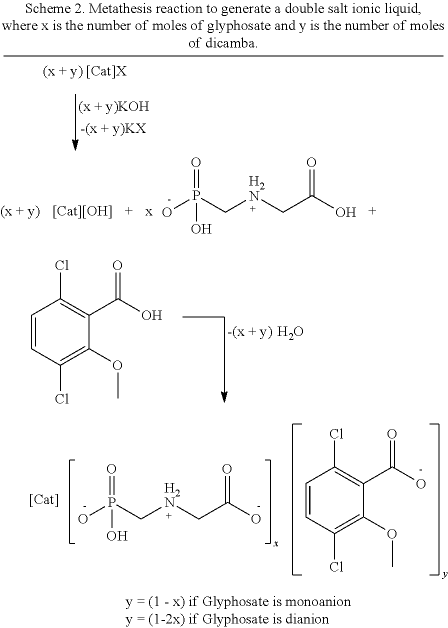

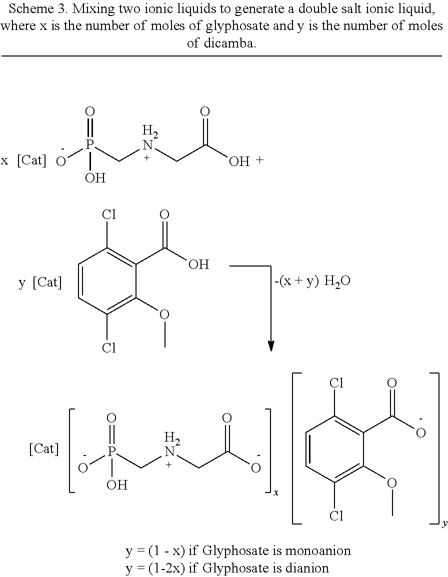

The purification of ionic liquids can be accomplished by techniques familiar to those skilled in the art of organic and inorganic synthesis. In some cases, ionic liquids can be purified by crystallization at the appropriate conditions of temperature and pressure (e.g., at low temperature and pressure). Such techniques can include the use of a solvent from which the ionic liquid can be crystallized at an appropriate temperature.

Synthesis of Double Salt Ionic Liquid Via Acid-Base Reaction

Double salt ionic liquids with two or more active herbicide anions can be synthesized through a direct acid base reaction (Scheme 4) in a properly selected organic solvent or water. A solution is prepared of a hydroxide salt, for example tetrabutylphosphonium hydroxide ([P(Bu)₄][OH]), in a suitable solvent. Next, the hydroxide anion can be protonated with a Brønsted acid to generate water, which can be easily removed by reduced pressure along with the organic solvent at the end of the reaction, and a new conjugate base, an anionic form of the original Brønsted acid after proton donation to the hydroxide anion.

Both dicamba (3,6-dichloro-2-methoxybenzoic acid) and glyphosate (N-(phosphonomethyl)glycine) can be utilized as the Brønsted acid either alone to generate an ionic liquid with a single mode of action, together in a defined ratio to generate an ionic liquid with two modes of action, or alongside additional Brønsted acids to generate an ionic liquid with several modes of action to combat herbicide resistance. Here, the ratio of the two or more anions is defined as a molar ratio. In the case provided in Scheme 4, the molar ratio of the anions is defined by x and y, which are numbers between 0 and 1 that must add up to 1. For example, if x equals 0.5 and y equals 0.5, there is an equal ratio of glyphosate and dicamba paired with a single cation ([Cat]) to give a double salt ionic liquid with two modes of action while still having a negligible volatility, low drift, and designable water solubility to prevent unwanted environmental release.

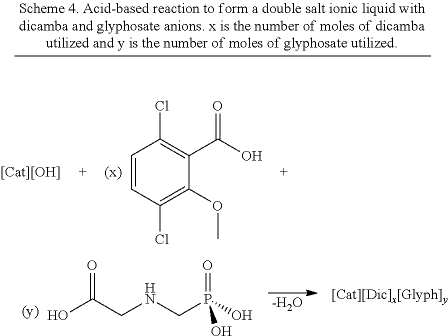

Synthesis of Double Salt Ionic Liquid Via Metathesis Reaction

Double salt ionic liquids with two or more active herbicide anions can be synthesized through a methathesis reaction (Scheme 5) in a properly selected organic solvent. A solution is prepared of a halide-based salt, for example tetrabutylphosphonium chloride ([P(Bu)₄][Cl]), in a suitable solvent. Next, the halide anion can be exchanged with a another herbicide-based anion to generate an insoluble inorganic salt, such as sodium chloride, which can be easily removed by centrifugation or filtration while the resulting organic salt remains soluble in the organic solvent. The solvent can be selected to dissolve the original starting materials and final product, but lead to the precipitation of the inorganic byproduct. Some solvents that could be utilized are methanol, ethanol, isopropanol, tetrahydrofuran, benzene, acetone, or other organic solvents.

Both dicamba (3,6-dichloro-2-methoxybenzoic acid) and glyphosate (N-(phosphonomethyl)glycine) can be utilized as salts, such as sodium glyphosate or sodium dicamba. Here, the ratio of the two or more anions is defined as a molar ratio. In the case provided in Scheme 5, the molar ratio of the anions is defined by x and y, which are numbers between 0 and 1 that must add up to 1. For example, if x equals 0.5 and y equals 0.5, there is an equal ratio of glyphosate and dicamba paired with a single cation ([Cat]) to give a double salt ionic liquid with two modes of action while still having a negligible volatility, low drift, and designable water solubility to prevent unwanted environmental release.

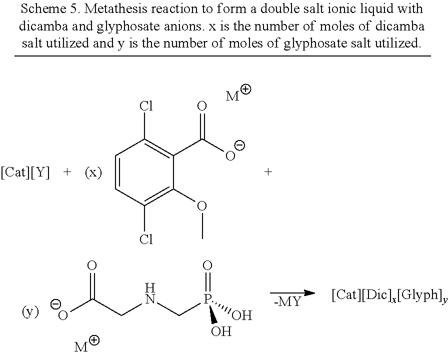

Synthesis of Double Salt Ionic Liquid Via Mixing

An additional strategy to synthesize a double salt ionic liquid is to mix two or more ionic liquids with a different anion identity (Scheme 6). Unlike in the case of the mixing of two solutions, the mixing of two ionic liquids results in a compound where the anions interact with one another. This results in a compound with a unique set of properties, such as melting point, viscosity, density, thermal decomposition, and water solubility with respect to the constituent salts. No solvent is required, but it can be utilized if the salts are solid at room temperature or possess a high viscosity. When a solvent is utilized to improve mixing, it can be removed by reduced pressure.

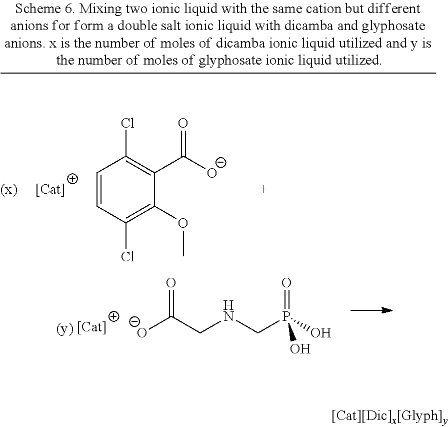

Herbicidal Ionic Liquid with a Polymeric Cation

The ionic liquid and double salt ionic liquids compositions containing a polymeric cation can be synthesized from a halide precursor in an organic solvent (Scheme 7). The ionic polymer precursor is treated with a strong base, including, but not limited to, potassium hydroxide to exchange the halide counter ion to obtain the cationic polymer with hydroxide anions. The subsequently formed inorganic salt, in this case a potassium halide salt, will precipitate out of solution. Next, the hydroxide anion can be protonated with a Brønsted acid to generate water, which can be easily removed by reduced pressure along with the organic solvent at the end of the reaction, and a new conjugate base, an anionic form of the original Brønsted acid after proton donation to the hydroxide anion.

Dicamba (3,6-dichloro-2-methoxybenzoic acid), glyphosate (N-(phosphonomethyl)glycine), and 2,4-D (2,4-dichlorophenoxyacetic acid) can be utilized as the Brønsted acid either alone to generate an ionic liquid with a single mode of action, together in a defined ratio to generate an ionic liquid with two modes of action, or alongside additional Brønsted acids to generate an ionic liquid with several modes of action to combat herbicide resistance. Here, a mass ratio (a to b) is utilized to define the ratio of the anions (dicamba to glyphsate) instead of a molar ratio due in part to the typical polydispersity present in polymeric compounds. The values within the mass ratio can be any value from 0 to 20. The utilized polymer can vary from an average molecular weight from as little as 100 g/mol to over 1,000,000 g/mol. The size of the polymeric chain is defined by the number of repeating monomer units, n in Scheme 7, which can range from n=1 to n=10,000. The polymeric cation and its molecular weight can be selected based on the incorporation of a targeted property. After removal of the organic solvent and generated water, an herbicide-base ionic liquid with a polymeric cation and 1, 2, or more herbicide anions can be isolated.

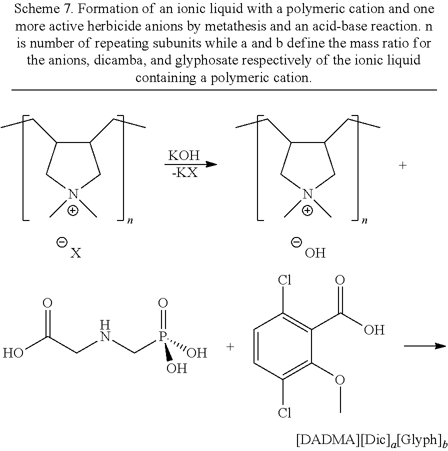

### Methods of Use

The disclosed compositions have many uses. For example, the disclosed compositions can be used to allow fine tuning and control of the rate of dissolution, solubility, and bioavailability, to allow control over physical properties and mechanical strength, to improve homogenous dosing, and to allow easier formulations. The disclosed compositions also make having compositions with additional functionality possible.

Converting an active herbicidal compound into an ionic liquid by introducing a second ion, or by providing such a combination of ions in solution, allows for enhancement of plant penetration and thus for improvement of delivery. These compositions can increase herbicidal performance due to new penetration mechanisms into the plant tissue. For example, cations with recognized surface and transport properties can be paired with the herbicidal anions described herein resulting in intensified uptake and translocation of the active compound.

The fact that the compositions are composed of cations and anions that form or can form an ionic liquid allows the tuning of hydrophilicity and hydrophobicity (among other properties), and thus control of surface wetting. The presence of a surfactant cation in an herbicidal composition alters the surface properties of the droplet, improves spreading and retention time, and changes the diffusion coefficient of the herbicide and its mobility. Additionally, the combination of two or more active chemicals in a single entity can reduce the number of additional chemicals such as adjuvants or surfactants required per application.

The compositions described herein are designed with dual functionality where both cation and anion add to the beneficial properties of the salt. In addition, secondary biological functions are introduced into the same herbicidal compound, where the broad spectrum of antimicrobial and fungicidal activity of the cations adds to the herbicidal activity. Moreover, if the herbicidal activity of the disclosed compositions is even only equivalent to the commercial products, the mass (weight %) of active ingredient can be reduced.

Converting an active herbicidal compound into a composition as disclosed herein allows at least for retaining the desired herbicidal activity, while the surface and physicochemical properties are modified. Therefore, control of solubility, reduction of volatility and drift during application and use, and reduced soil and groundwater mobility can be observed. As a result, herbicidal compositions can be applied less frequently, stay on the plant leaves longer, and therefore reduce the need for repeat applications.

In the long-term, these herbicidal compositions can be advantageous to the consumers both economically and environmentally. Ion pairing of ionic liquids even when dissolved (in contrast to known high melting metal salt forms), suggests that pairing herbicides with penetration enhancers (e.g., fatty quaternary ammoniums) will result in faster plant penetration. The antibacterial and/or antifungal activity of the chosen cations can offer additional advantages. In addition, the compositions described herein provide dual biological functionality in one compound. For instance, the antibacterial/antifungal activity of the chosen cations can offer additional advantages in plant protection. Further, the synthesized compounds described herein have ionic structures, are not volatile, and their vapor pressure at moderate temperatures is practically immeasurable. This reduces or eliminates volatilization during and after application, thereby reducing the contamination of non-target plants and reducing worker exposure. The long alkyl chains of the cations cause the products to have surfactant properties thus no additional surfactant is needed. In addition, the pairs of ion-containing anion of 2-(4-chloro-2-methylphenoxy) propionate, for example, depending on the type of cation salts, can be hydrophobic or hydrophilic. By changing the cation in the resulting salts, the hydrophobicity and hydrophilicity can be tuned. The chosen cations can decrease the water solubility of the herbicides. Polymeric cations can reduce the water solubility and mobility of the disclosed compositions.

A further use for the compositions described herein includes the treatment of seeds. As used herein, “seed” includes the seed of a native plant, hybrid plant, transgenic plant, genetically modified plant, or a combination of these. In some embodiments, the treatment of seeds with one or more of the compositions described herein can impart heribicidal properties to the seeds and the resulting plant's roots and shoots. The seeds can be treated according to methods known to those of skill in the art, including, for example, seed dressing, seed coating, seed dusting, seed soaking, and seed pelleting. In some embodiments, the compositions described herein can be coated on the surface of the seed and/or can penetrate into the seed.

The compositions disclosed herein that contain ionic herbicidal actives can be used in the same way as the actives themselves are used by themselves.

Administration and Delivery

Formulations for administration can include sprays, liquids, and powders. The disclosed compositions having hydrophobic ions can be particularly useful in such applications because they can adhere to the surface longer when exposed to water or other fluids than would a similar hydrophilic salt. Likewise, compositions comprising herbicide anions and polymeric cations can be expected to resist erosion from rainfall. It should also be noted that herbicides applied to plant leaves can be less prone to be lost by rain even if it follows application.

When one or more ions in the disclosed compositions are herbicidal actives, an effective amount of the composition can be administered to an area to control plants. Techniques for contacting such surfaces and areas with the disclosed compositions can include, spraying, coating, dipping, immersing, or pouring the composition into or onto the surface or area. The precise technique will depend on such factors as the type and amount of infestation or contamination, the size of the area, the amount of composition needed, preference, cost, and the like.

The disclosed compositions can be dissolved in a suitable solvent or carrier as are disclosed herein. This method can enhance the delivery of one or more active ions in the composition. Further, as is disclosed herein, this method can create a synergistic effect among the various ions present. While not wishing to be bound by theory, the dissociation coefficient of various ions in an ionic liquid can be different in different solvents. Thus, ions in an ionic liquid can dissociate freely in one solvent and cluster in another. This phenomenon can be utilized to provide formulations of compounds that are difficult to deliver (e.g., decrease the water solubility of herbicides and increase the penetration into the leaf). That is, compounds can be formed into an ionic liquid, as described herein, and then dissolved in a suitable solvent to provide an easily deliverable solution. A synergistic effect can be observed upon administration to a subject, when ions cluster and act together, rather than independently.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

All chemicals used were of analytical grade, purchased from Sigma-Aldrich (St. Louis, Mo.) or Alfa Aesar (Ward Hil, Mass.), and used without further purification unless otherwise noted.

### Example 1: Double Salt Herbicidal Ionic Liquids with a Cholinium Cation and Two Anions

### Example 1-I. Cholinium 2-[(phosphonomethyl)amino]acetate-3,6-dichloro-2-methoxy-benzoate [Cho][HGlyph]_{0.10}[Dic]_{0.90}

A round-bottom flask (100 mL) equipped with a magnetic Teflon coated stirring bar was charged with 0.0410 mol choline hydroxide (as a 45% solution in methanol) and 30 mL methanol. To the obtained solution 0.0041 mol solid 2-[(phosphonomethyl)amino] acetic acid (glyphosate) and 0.0369 mol solid 3,6-dichloro-2-methoxybenzoic acid (dicamba) were added consequtively. The reaction mixture was stirred for 24 h at room temperature, then the volatiles were removed on a Rotary evaporator using water bath which temperature did not exceed 45° C. After all the solvent was removed, the compound was obtained as a yellow solid and were additionally dried under high-vacuum at 45° C. for 3 days. ¹H NMR (D₂O) δ (ppm) 7.26 (m, 0.91H), 7.12 (m, 0.90H), 3.93 (m, 2.01H), 3.81 (s, 2.75H), 3.67 (s, 0.20H), 3.39 (m, 2.01H), 3.15 (d, 0.20H, overlapped with CH₃ from cholinium cation), 3.08 (s, 9H, overlapped with CH₂ group from glyphosate); ³¹P NMR (D₂O) δ (ppm) 8.72.

### Example 1-II. Cholinium 2-[(phosphonomethyl)amino]acetate-3,6-dichloro-2-methoxy-benzoate [Cho][HGlyph]_{0.44}[Dic]_{0.60}

A round-bottom reaction flask (100 mL) equipped with a magnetic stirrer was charged with 0.0410 mol choline hydroxide (as a 45% solution in methanol) and 30 mL methanol. To the obtained solution 0.0164 mol solid 2-[(phosphonomethyl)amino] acetic acid (glyphosate) and 0.0246 mol solid 3,6-dichloro-2-methoxybenzoic acid (dicamba) were added. The reaction mixture was stirred for 24 h at room temperature when the volatiles were evaporated using a Rotovapor and an water baths whose temperature did not exceed 45° C. After all the solvent was removed, the compound was obtained as a yellow solid. ¹H NMR (D₂O) δ (ppm) 7.23 (m, 0.59H), 7.08 (m, 0.60H), 3.90 (m, 2.04H), 3.77 (s, 1.84H), 3.64 (s, 0.80H), 3.36 (m, 2.00H), 3.12 (d, 0.80H, overlapped with CH₃ from cholinium cation), 3.05 (s, 9H, overlapped with CH₂ group from glyphosate); ³¹P NMR (D₂O) δ (ppm) 8.72.

### Example 1-III. Cholinium 2-[(phosphonomethyl)amino]acetate-3,6-dichloro-2-methoxy-benzoate [Cho][HGlyph]_{0.50}[Dic]_{0.50}

A round-bottom reaction flask (100 mL) equipped with a magnetic stirrer was charged with 0.0410 mol choline hydroxide (as a 45% solution in methanol) and 30 mL methanol. To the obtained solution 0.0205 mol solid 2-[(phosphonomethyl)amino] acetic acid (glyphosate) and 0.0205 mol solid 3,6-dichloro-2-methoxybenzoic acid (dicamba) were added. The reaction mixture was stirred for 24 h at room temperature when the volatiles were evaporated using a Rotovapor and an water baths whose temperature did not exceed 45° C. After all the solvent was removed, the compound was obtained as a yellow solid. ¹H NMR (D₂O) δ (ppm) 7.24 (m, 0.51H), 7.08 (m, 0.50H), 3.89 (m, 2.03H), 3.76 (s, 1.77H), 3.63 (s, 0.98H), 3.34 (m, 2.00H), 3.11 (d, 1.06H, overlapped with CH₃ from cholinium cation), 3.04 (s, 9.02H, overlapped with CH₂ group from glyphosate); ³¹P NMR (D₂O) δ (ppm) 8.70.

### Example 1-IV. Cholinium 2-[(phosphonomethyl)amino]acetate-3,6-dichloro-2-methoxy-benzoate [Cho][HGlyph]_{0.80}[Dic]_{0.20}

A round-bottom reaction flask (100 mL) equipped with a magnetic stirrer was charged with 0.0410 mol choline hydroxide (as a 45% solution in methanol) and 30 mL methanol. To the obtained solution 0.0328 mol solid 2-[(phosphonomethyl)amino] acetic acid (glyphosate) and 0.0082 mol solid 3,6-dichloro-2-methoxybenzoic acid (dicamba) were added. The reaction mixture was stirred for 24 h at room temperature when the volatiles were evaporated using a Rotovapor and a water bath whose temperature did not exceed 45° C. After all the solvent was removed, the compound was obtained as a yellow solid. ¹H NMR (D₂O) δ (ppm) 7.30 (m, 0.21H), 7.12 (m, 0.20H), 3.97 (m, 2.00H), 3.80 (s, 0.72H), 3.67 (s, 1.60H), 3.42 (m, 2.00H), 3.13 (d, 1.73H, overlapped with CH₃ from cholinium cation), 3.09 (s, 8.88H, overlapped with CH₂ group from glyphosate); ³¹P NMR (D₂O) δ (ppm) 8.83.

### Example 1-V. Cholinium 2-[(phosphonomethyl)amino]acetate-3,6-dichloro-2-methoxy-benzoate [Cho][Glyph]_{0.33}[Dic]_{0.33}

A round-bottom reaction flask (100 mL) equipped with a magnetic stirrer was charged with 0.0410 mol choline hydroxide (as a 45% solution in methanol) and 30 mL methanol. To the obtained solution 0.0135 mol solid 2-[(phosphonomethyl)amino] acetic acid (glyphosate) and 0.0135 mol solid 3,6-dichloro-2-methoxybenzoic acid (dicamba) were added. The reaction mixture was stirred for 24 h at room temperature when the volatiles were evaporated using a Rotovapor and a water bath whose temperature did not exceed 45° C. After all the solvent was removed, the compound was obtained as a yellow solid. ¹H NMR (D₂O) δ (ppm) 7.30 (m, 0.33H), 7.12 (m, 0.32H), 3.95 (m, 2.06H), 3.80 (s, 0.97H), 3.63 (s, 0.67H), 3.41 (m, 2.04H), 3.09 (s, 9H), 2.96 (d, 0.77H).

### Example 2: Double Salt Herbicidal Ionic Liquids with a Tetrabutylammonium Cation and Two Anions

### Example 2-I: Tetrabutylammonium 2-[(phosphonomethyl)amino]acetate-3,6-dichloro-2-methoxy-benzoate [N_{4,4,4,4}][HGlyph]_{0.36}[Dic]_{0.64}

A round-bottom flask (100 mL) equipped with a magnetic stirrer was charged with 0.0036 mol solid 2-[(phosphonomethyl)amino] acetic acid (glyphosate), 0.0064 mol solid 3,6-dichloro-2-methoxybenzoic acid (dicamba), and 50 mL methanol. To the obtained suspension 0.010 mol [NBu₄][HO] (as a 40 wt % of a solution in methanol) was added. The reaction mixture was stirred for ˜20 h at room temperature when solvent was evaporated using a rotovapor and at 60° C. ¹H NMR (DMSO-d6) δ (ppm) 7.13 (m, 0.63H), 7.02 (m, 0.64H), 3.79 (s, 1.76H), 3.20 (m, 8.75H), 2.76 (s, 0.72H), 1.57 (m, 8H), 1.32 (m, 8H), 0.95 (m, 12H).

### Example 2-11: Tetrabutylammonium 2-[(phosphonomethyl)amino]acetate-3,6-dichloro-2-methoxy-benzoate [N_{4,4,4,4}][Glyph]_{0.33}[Dic]_{0.33}

A round-bottom flask (100 mL) equipped with a magnetic stirrer was charged with 0.0066 mol solid 2-[(phosphonomethyl)amino] acetic acid (glyphosate), 0.0066 mol solid 3,6-dichloro-2-methoxybenzoic acid (dicamba), and 50 mL methanol. To the obtained suspension 0.020 mol [NBu₄][HO] (as a 40 wt % of a solution in methanol) was added. The reaction mixture was stirred for ˜20 h at room temperature when solvent was evaporated using a rotovapor at 60° C. ¹H NMR (DMSO-d6) δ (ppm) 7.12 (m, 1H), 7.02 (m, 1H), 3.80 (s, 3H), 3.20 (m, 24H), 2.75 (s, 2H), 2.32 (d, 2H), 1.57 (m, 24H), 1.32 (m, 24H), 0.94 (m, 36H).

### Example 3: Double Salt Herbicidal Ionic Liquids with a Tetrabutylphosphonium Cation and Two Anions

### Example 3-I: Tetrabutylphosphonium 2-[(phosphonomethyl)amino]acetate-3,6-dichloro-2-methoxy-benzoate [P_{4,4,4,4}][Glyph]_{0.20}[Dic]_{0.60}

A 100 mL flask was charged with 0.0040 mol solid 3,6-dichloro-2-methoxybenzoic acid (dicamba), 0.0120 mol solid 2-[(phosphonomethyl)amino] acetic acid (glyphosate), and 60 mL methanol. To the obtained mixture 0.0200 mol [PBu₄][HO] was added and the reaction mixture was stirred at RT for 2 h when all the solid from the mixture disappeared. The solvent was evaporated using a Rotovapor and a water bath heated at 50° C. and the product was obtained as a wax. ¹H NMR (DMSO-d₆) δ (ppm) 7.12 (m, 0.63H), 7.00 (m, 0.63H), 3.79 (s, 1.80H, overlapped with OH), 2.67 (s, 0.41H), 2.22 (m, 8H), 2.13 (d, 0.41H), 1.42 (m, 16H), 0.90 (m, 12H).

### Example 3-II: Tetrabutylphosphonium 2-[(phosphonomethyl)amino]acetate-3,6-dichloro-2-methoxy-benzoate [P_{4,4,4,4}][Glyph]_{0.33}[Dic]_{0.33}

A 100 mL flask was charged with 0.006 mol solid 3,6-dichloro-2-methoxybenzoic acid (dicamba), 0.006 mol solid 2-[(phosphonomethyl)amino] acetic acid (glyphosate), and 60 mL methanol. To the obtained mixture 0.018 mol [PBu₄][HO] was added and the reaction mixture was stirred at RT for 2 h when all the solid from the mixture disappeared. The solvent was evaporated using a Rotovapor and a water bath heated at 50° C. and the product was obtained as a wax. ¹H NMR (D₂O) δ (ppm) 7.13 (m, 1H), 7.01 (m, 1H), 3.79 (s, 3H), 2.91 (s, 2H), 2.52 (d, 2H, overlapped with dmso peak), 2.21 (m, 24H), 1.45 (m, 24H), 1.40 (m, 24H), 0.90 (m, 36H). ¹H NMR (DMSO-d6) δ (ppm) 7.29 (m, 1H), 7.14 (m, 1H), 3.81 (s, 3H), 3.63 (s, 2H), 3.03 (d, 2H), 2.06 (m, 24H), 1.43 (m, 48H), 0.82 (m, 36H) ³¹P NMR (D₂O-d6) δ (ppm) 33.2; 8.02.

### Example 3-III: Tetrabutylphosphonium 2-[(phosphonomethyl)amino]acetate-3,6-dichloro-2-methoxy-benzoate [P_{4,4,4,4}][HGlyph]_{0.30}[Dic]_{0.40}

A 100 mL flask was charged with 0.0080 mol solid 3,6-dichloro-2-methoxybenzoic acid (dicamba), 0.0060 mol solid 2-[(phosphonomethyl)amino] acetic acid (glyphosate), and 60 mL methanol. To the obtained mixture 0.0200 mol [PBu₄][HO] was added and the reaction mixture was stirred at RT for 2 h when all the solid from the mixture disappeared. The solvent was evaporated using a Rotovapor and a water bath heated at 50° C. and the product was obtained as a wax. ¹H NMR (DMSO-d₆) δ (ppm) 7.13 (m, 0.41H), 7.02 (m, 0.40H), 3.81 (s, 1.80H, overlapped with OH), 2.70 (s, 0.31H), 2.22 (m, 8.97H, overlapped with CH₂ from glyphosate), 1.46 (m, 17H), 0.91 (m, 13H).

### Example 3-IV: Tetrabutylphosphonium 2-[(phosphonomethyl)amino]acetate-3,6-dichloro-2-methoxy-benzoate [P_{4,4,4,4}][Glyph]_{0.37}[Dic]_{0.25}

A 100 mL flask was charged with 0.0025 mol solid 3,6-dichloro-2-methoxybenzoic acid (dicamba), 0.0037 mol solid 2-[(phosphonomethyl)amino] acetic acid (glyphosate), and 60 mL methanol. To the obtained mixture 0.0100 mol [PBu₄][HO] was added and the reaction mixture was stirred at RT for 2 h when all the solid from the mixture disappeared. The solvent was evaporated using a Rotovapor and a water bath heated at 50° C. and the product was obtained as a wax. ¹H NMR (DMSO-d₆) δ (ppm) 7.12 (m, 0.26H), 6.99 (m, 0.25H), 3.80 (s, 0.80H), 2.85 (s, 0.75H), 2.45 (d, 0.75H), 2.23 (m, 8.89H), 1.47 (m, 18H), 0.93 (m, 13.5H).

### Example 3-V: Tetrabutylphosphonium 2-[(phosphonomethyl)amino]acetate-3,6-dichloro-2-methoxy-benzoate [P_{4,4,4,4}][Glyph]_{0.43}[Dic]_{0.14}

A 100 mL flask was charged with 0.0028 mol solid 3,6-dichloro-2-methoxybenzoic acid (dicamba), 0.0086 mol solid 2-[(phosphonomethyl)amino] acetic acid (glyphosate), and 60 mL methanol. To the obtained mixture 0.0200 mol [PBu₄][HO] was added and the reaction mixture was stirred at RT for 2 h when all the solid from the mixture disappeared. The solvent was evaporated using a Rotovapor and a water bath heated at 50° C. and the product was obtained as a wax. ¹H NMR (DMSO-d₆) δ (ppm) 7.12 (m, 0.14H), 7.01 (m, 0.14H), 3.81 (s, 0.49H), 2.92 (s, 0.86H), 2.52 (CH2 peak from glyphosate overlapped with dmso-d6), 2.26 (m, 8.48H), 1.43 (m, 17.5H), 0.91 (m, 13.16H).

### Example 4: Double Salt Herbicidal Ionic Liquids with a Benzalkonium Cation and Two Anions

### Example 4-I. Benzalkonium 2-[(phosphonomethyl)amino]acetate-3,6-dichloro-2-methoxy-benzoate [BA][HGlyph]_{0.80}[Dic]_{0.20}

A 100 mL flask equipped with a magnetic stirrer was charged with 0.050 mol benzalkonium chloride in methanol. To the obtained mixture 0.050 mol solid KOH was added and the reaction mixture was stirred for 16 h at room temperature. The obtained suspension was filtered through Celite resulting in a solution of benzalkonium hydroxide in methanol. In a second step, to the solution of benzalkonium chloride in methanol 0.010 mol solid 3,6-dichloro-2-methoxybenzoic acid (dicamba), 0.040 mol solid 2-[(phosphonomethyl)amino] acetic acid (glyphosate). The reaction mixtures were stirred for 24 h at room temperature when suspensions were obtained. The volatiles were evaporated using a rotovapor and a water bath heated at 60° C. resulting in the formation of waxes. ¹H NMR (DMSO-d6) δ (ppm) 7.53 (m, 5H), 7.16 (m, 0.2H), 7.03 (m, 0.2H), 4.60 (s, 2H), 3.79 (s, 0.6H), 3.28 (m, 1.6H), 2.98 (s, 6H), 1.77 (s, 1.6H), 1.25 (m, 20H), 0.87 (m, 3H); ¹³C NMR (DMSO-d6) δ 165.30, 151.66, 133.42, 130.67, 129.32, 128.71, 128.05, 126.92, 125.61, 125.47, 66.63, 63.92, 61.30, 49.53, 31.76, 29.52, 29.47, 29.39, 29.26, 29.17, 28.99, 26.32, 22.55, 22.28, 14.40.

### Example 4-II: Benzalkonium 2-[(phosphonomethyl)amino]acetate-3,6-dichloro-2-methoxy-benzoate [BA][HGlyph]_{0.06}[Dic]_{0.40}

A 100 mL flask equipped with a magnetic stirrer was charged with 0.050 mol benzalkonium chloride in methanol. To the obtained mixture 0.050 mol solid KOH was added and the reaction mixture was stirred for 16 h at room temperature. The obtained suspension was filtered through Celite resulting in a solution of benzalkonium hydroxide in methanol. In a second step, to the solution of benzalkonium chloride in methanol 0.020 mol solid 3,6-dichloro-2-methoxybenzoic acid (dicamba), 0.030 mol solid 2-[(phosphonomethyl)amino] acetic acid (glyphosate). The reaction mixtures were stirred for 24 h at room temperature when suspensions were obtained. The volatiles were evaporated using a rotovapor and a water bath heated at 60° C. resulting in the formation of waxes. ¹H NMR (DMSO-d6) δ (ppm) 7.57 (m, 5H), 7.14 (m, 0.4H), 7.04 (m, 0.4H), 4.58 (s, 2H), 3.79 (s, 1.2H), 3.28 (m, 1.2H), 2.97 (s, 6H), 1.76 (s, 1.2H), 1.26 (m, 21H), 0.85 (m, 3H); ¹³C NMR (DMSO-d6) δ 165.29, 151.65, 133.42, 130.66, 129.33, 128.72, 128.05, 126.91, 125.61, 125.47, 66.64, 63.91, 61.30, 49.53, 31.75, 29.51, 29.46, 29.39, 29.25, 29.17, 28.97, 26.33, 22.54, 22.27, 14.41.

### Example 4-III: Benzalkonium 2-[(phosphonomethyl)amino]acetate-3,6-dichloro-2-methoxy-benzoate [BA][HGlyph]_{0.50}[Dic]_{0.50}

A 100 mL flask equipped with a magnetic stirrer was charged with 0.050 mol benzalkonium chloride in methanol. To the obtained mixture 0.050 mol solid KOH was added and the reaction mixture was stirred for 16 h at room temperature. The obtained suspension was filtered through Celite resulting in a solution of benzalkonium hydroxide in methanol. In a second step, to the solution of benzalkonium chloride in methanol 0.025 mol solid 3,6-dichloro-2-methoxybenzoic acid (dicamba), 0.025 mol solid 2-[(phosphonomethyl)amino] acetic acid (glyphosate). The reaction mixtures were stirred for 24 h at room temperature when suspensions were obtained. The volatiles were evaporated using a rotovapor and a water bath heated at 60° C. resulting in the formation of waxes. ¹H NMR (DMSO-d6) δ (ppm) 7.53 (m, 5H), 7.13 (m, 0.5H), 7.03 (m, 0.5H), 4.60 (s, 2H), 3.80 (s, 1.6H), 3.28 (m, 1H), 2.98 (s, 6H), 1.77 (s, 1H), 1.25 (m, 21H), 0.87 (m, 3H); ¹³C NMR (DMSO-d6) δ 165.30, 151.65, 133.42, 130.68, 129.32, 128.71, 128.06, 126.92, 125.62, 125.47, 66.63, 63.93, 61.30, 49.53, 31.77, 29.52, 29.47, 29.39, 29.26, 29.17, 28.99, 26.33, 22.55, 22.28, 14.41.

### Example 4-IV: Benzalkonium 2-[(phosphonomethyl)amino]acetate-3,6-dichloro-2-methoxy-benzoate [BA][HGlyph]_{0.40}[Dic]_{0.60}

A 100 mL flask equipped with a magnetic stirrer was charged with 0.050 mol benzalkonium chloride in methanol. To the obtained mixture 0.050 mol solid KOH was added and the reaction mixture was stirred for 16 h at room temperature. The obtained suspension was filtered through Celite resulting in a solution of benzalkonium hydroxide in methanol. In a second step, to the solution of benzalkonium chloride in methanol 0.030 mol solid 3,6-dichloro-2-methoxybenzoic acid (dicamba), 0.020 mol solid 2-[(phosphonomethyl)amino] acetic acid (glyphosate). The reaction mixtures were stirred for 24 h at room temperature when suspensions were obtained. The volatiles were evaporated using a rotovapor and a water bath heated at 60° C. resulting in the formation of waxes. ¹H NMR (DMSO-d6) δ (ppm) 7.53 (m, 5H), 7.14 (m, 0.6H), 7.03 (m, 0.6H), 4.60 (s, 2H), 3.80 (s, 1.8H), 3.28 (m, 0.8H), 2.98 (s, 6H), 1.77 (s, 0.8H), 1.25 (m, 20H), 0.87 (m, 3H); ¹³C NMR (DMSO-d6) δ 165.31, 151.67, 133.42, 130.66, 129.32, 128.70, 128.05, 126.92, 125.60, 125.47, 66.64, 63.92, 61.30, 49.54, 31.76, 29.52, 29.47, 29.40, 29.26, 29.17, 28.98, 26.32, 22.55, 22.27, 14.40.

### Example 4-V: Benzalkonium 2-[(phosphonomethyl)amino]acetate-3,6-dichloro-2-methoxy-benzoate [BA][HGlyph]_{0.20}[Dic]_{0.80}

A 100 mL flask equipped with a magnetic stirrer was charged with 0.050 mol benzalkonium chloride in methanol. To the obtained mixture 0.050 mol solid KOH was added and the reaction mixture was stirred for 16 h at room temperature. The obtained suspension was filtered through Celite resulting in a solution of benzalkonium hydroxide in methanol. In a second step, to the solution of benzalkonium chloride in methanol 0.040 mol solid 3,6-dichloro-2-methoxybenzoic acid (dicamba), 0.010 mol solid 2-[(phosphonomethyl)amino] acetic acid (glyphosate). The reaction mixtures were stirred for 24 h at room temperature when suspensions were obtained. The volatiles were evaporated using a rotovapor and a water bath heated at 60° C. resulting in the formation of waxes. ¹H NMR (DMSO-d6) δ (ppm) 7.55 (m, 5H), 7.15 (m, 0.8H), 7.01 (m, 0.8H), 4.60 (s, 2H), 3.80 (s, 2.4H), 3.27 (m, 0.4H), 2.98 (s, 6H), 1.77 (s, 0.4H), 1.25 (m, 20H), 0.87 (m, 3H)′; ¹³C NMR (DMSO-d6) δ 165.30, 151.66, 133.42, 130.67, 129.32, 128.71, 128.05, 126.92, 125.61, 125.47, 66.63, 63.92, 61.30, 49.53, 31.76, 29.52, 29.47, 29.39, 29.26, 29.17, 28.99, 26.32, 22.55, 22.28, 14.40.

### Example 5: Double Salt Herbicidal Ionic Liquids with a Trihexyltetradecyl Phosphonium Cation and Two Anions

### Example 5-I: Trihexyltetradecylphosphonium 2-[(phosphonomethyl)amino]acetate-3,6-dichloro-2-methoxy-benzoate} [P_{6,6,6,14}][Glyph]_{0.40}[Dic]_{0.20}

[P_{6,6,6,14}][Dicamba] and [P_{6,6,6,14}]₂[Glyph] were mixed in the appropriate molar ratios. The obtained mixtures were stirred for 2 h at 50° C. and the residual water was removed using high vacuum and at 60° C. ¹H NMR (DMSO-d6) δ (ppm) 7.09 (m, 0.20H), 6.97 (m, 0.20H), 3.79 (s, 0.47H), 3.14 (s, 0.81H), 2.79 (d, 0.81H), 2.22 (m, 8.0H), 1.46 (m, 8.0H), 1.38 (m, 8.0H), 1.28 (m, 30.0H), 0.86 (t, 12H).

### Example 5-11: Trihexyltetradecylphosphonium 2-[(phosphonomethyl)amino]acetate-3,6-dichloro-2-methoxy-benzoate [P_{6,6,6,14}][Glyph]_{0.32}[Dic]_{0.36}

[P_{6,6,6,14}][Dicamba] and [P_{6,6,6,14}]₂[Glyph] were mixed in the appropriate molar ratios. The obtained mixtures were stirred for 2 h at 50° C. and the residual water was removed using high vacuum and at 60° C. ¹H NMR (DMSO-d6) δ (ppm) 7.09 (m, 0.32H), 6.97 (m, 0.32H), 3.79 (s, 0.92H), 3.14 (s, 0.65H), 2.72 (d, 0.64H), 2.21 (m, 8.0H), 1.47 (m, 8.0H), 1.37 (m, 8.0H), 1.28 (m, 30.0H), 0.86 (t, 12.7H).

### Example 5-III: Trihexyltetradecylphosphonium 2-[(phosphonomethyl)amino]acetate-3,6-dichloro-2-methoxy-benzoate [P_{6,6,6,14}][Glyph]_{0.25}[Dic]_{0.50}

[P_{6,6,6,14}][Dicamba] and [P_{6,6,6,14}]₂[Glyph] were mixed in the appropriate molar ratios. The obtained mixtures were stirred for 2 h at 50° C. and the residual water was removed using high vacuum and at 60° C. ¹H NMR (DMSO-d6) δ (ppm) 7.11 (m, 0.49H), 7.01 (m, 0.49H), 3.82 (s, 1.49H), 3.17 (s, 0.51H), 2.75 (d, 0.52H), 2.19 (m, 8.1H), 1.46 (m, 8.0H), 1.38 (m, 8.0H), 1.28 (m, 30.0H), 0.87 (t, 12.7H).

### Example 5-IV: Trihexyltetradecylphosphonium 2-[(phosphonomethyl)amino]acetate-3,6-dichloro-2-methoxy-benzoate [P_{6,6,6,14}][Glyph]_{0.13}[Dic]_{0.74}

[P_{6,6,6,14}][Dicamba] and [P_{6,6,6,14}]₂[Glyph] were mixed in the appropriate molar ratios. The obtained mixtures were stirred for 2 h at 50° C. and the residual water was removed using high vacuum and at 60° C. ¹H NMR (DMSO-d6) δ (ppm) 7.14 (m, 0.74H), 7.00 (m, 0.73H), 3.80 (s, 2.28H), 3.20 (s, 0.26H), 2.75 (d, 0.26H), 2.21 (m, 8.2H), 1.46 (m, 8.0H), 1.37 (m, 8.0H), 1.28 (m, 30.0H), 0.86 (t, 12H).

The physical state of selected DSILs from Examples 1-5 are shown in Table 2 below.

TABLE 2
Physical state of DSILs (selected examples)

| | | | Physical |
|---|---|---|---|
| Cation | Example | Composition | State |
| Cholinium | 1-I | [Cho][HGlyph]_{0.10}[Dic]_{0.90} | Wax |
| | 1-II | [Cho][HGlyph]_{0.40}[Dic]_{0.60} | Wax |
| | 1-III | [Cho][HGlyph]_{0.50}[Dic]_{0.50} | Wax |
| | 1-IV | [Cho][HGlyph]_{0.80}[Dic]_{0.20} | Wax |
| | 1-V | [Cho][Glyph]_{0.33}[Dic]_{0.33} | Wax |
| Tetrabutyl | 2-I | [NBu₄][HGlyph]_{0.36}[Dic]_{0.64} | Wax |
| ammonium | 2-II | [NBu₄][Glyph]_{0.33}[Dic]_{0.33} | Wax |
| Tetrabutyl | 3-I | [P_{4,4,4,4}][Glyph]_{0.20}[Dic]_{0.60} | Wax |
| phosphonium | 3-III | [P_{4,4,4,4}][Glyph]_{0.30}[Dic]_{0.40} | Wax |
| | 3-II | [P_{4,4,4,4}][Glyph]_{0.33}[Dic]_{0.33} | Liquid |
| | 3-IV | [P_{4,4,4,4}][Glyph]_{0.37}[Dic]_{0.25} | Wax |
| | 3-V | [P_{4,4,4,4}][Glyph]_{0.43}[Dic]_{0.14} | Wax |
| Benzalkonium | 4-I | [BA][HGlyph]_{0.80}[Dic]_{0.20} | Wax |
| | 4-II | [BA][HGlyph]_{0.60}[Dic]_{0.40} | Wax |
| | 4-III | [BA][HGlyph]_{0.50}[Dic]_{0.50} | Wax |
| | 4-IV | [BA][HGlyph]_{0.40}[Dic]_{0.60} | Wax |
| | 4-V | [BA][HGlyph]_{0.20}[Dic]_{0.80} | Wax |
| Trihexyltetradecyl | 5-I | [P_{6,6,6,14}][Glyph]_{0.40}[Dic]_{0.20} | Liquid |
| phosphonium | 5-II | [P_{6,6,6,14}][Glyph]_{0.32}[Dic]_{0.36} | Liquid |
| | 5-III | [P_{6,6,6,14}][Glyph]_{0.25}[Dic]_{0.50} | Liquid |
| | 5-IV | [P_{6,6,6,14}][Glyph]_{0.13}[Dic]_{0.74} | Liquid |

### Example 6: Double Salt Herbicidal Ionic Liquids with an Ammonium Cation and Two Anions

### Example 6-I—Ammonium 3,6-dichloro-2-methoxy-benzoate N-(phosphonomethyl) glycinate ([NH₄]₃[Glyph]₁[Dic]₁) (3:1:1 Molar Ratio)

In a round-bottom flask, 0.15 mol of Ammonium hydroxide dissolved in water was combined with 0.05 mol of N-(phosphonomethyl) glycine and 0.05 mol of 3,6-dichloro-2-methoxy-benzoic acid dissolved in 25 mL of anhydrous methanol. The mixture was stirred for 1 h at room temperature. Then, the solvent was evaporated using a rotary evaporator and the obtained product was dried under reduced pressure at 50° C. for 24 h.

### Example 6-II—Ammonium 3,6-dichloro-2-methoxy-benzoate N-(phosphonomethyl) glycinate ([NH₄]₂ [HGlyph]₁[Dic]₁) (2:1:1 Molar Ratio)

In a round-bottom flask, 0.10 mol of Ammonium hydroxide dissolved in water was combined with 0.05 mol of N-(phosphonomethyl) glycine and 0.05 mol of 3,6-dichloro-2-methoxy-benzoic acid dissolved in 25 mL of anhydrous methanol. The mixture was stirred for 1 h at room temperature. Then, the solvent was evaporated using a rotary evaporator and the obtained product was dried under reduced pressure at 50° C. for 24 h.

### Example 7: Herbicidal Ionic Liquids with a Polymeric Cation and One Anion Poly(Diallyldimethylammonium)N-(Phosphonomethyl) Glycinate (p-[DADMA][Glyph])

In a round-bottom flask, 0.10 mol of poly(diallyldimethylammonium chloride) was dissolved in 25 mL of anhydrous methanol followed by adding 0.10 mol of potassium hydroxide dissolved in 25 mL of anhydrous methanol and the mixture was stirred for 1 h at room temperature. The inorganic by-product (0.10 mol of potassium chloride) precipitated as a white solid and was carefully separated from solution by filtration. Then, N-(phosphonomethyl) glycine (glyphosate) was poured into the flask to neutralize the poly(ammonium hydroxides) in the filtrate. Then, the solvent was evaporated using a rotary evaporator and the obtained product was dried under reduced pressure at 50° C. for 24 h. ¹H NMR (CDCl₃, 298K, 300 MHz) δ (ppm) 1.36 (s, 4H), 1.54 (s, 4H), 2.69 (s, 2H), 3.03 (s, 2H), 3.19 (s, 4H), 3.31 (s, 6H), 3.59 (s, 2H), ¹³C NMR (CDCl₃, 298K, 100 MHz) 4H), 1.54 (s, 4H), 2.69 (s, 2H), 3.03 (s, 2H), 3.19 (s, ³¹P NMR (CDCl₃, 298K, 121 MHz) δ (ppm) 7.5 (s); Elemental analysis calcd (%) for C₁₃H₂₇N₂O₅P (324.18) C, 48.44; H, 8.44; N, 8.69, found C, 48.32; H, 8.81; N, 8.51.

### Example 8: Double Salt Herbicidal Ionic Liquids with a Polymeric Cation and Two Anions

### Example 8-I—Poly(diallyldimethylammonium)N-(phosphonomethyl) glycinate 3,6-dichloro-2-methoxy-benzoate (p-[DADMA][Dic][Glyph] (1:7.2 Mass Ratio))

In a round-bottom flask, 0.10 mol of poly(diallyldimethylammonium chloride) was dissolved in 25 mL of anhydrous methanol followed by adding 0.10 mol of potassium hydroxide dissolved in 25 mL of anhydrous methanol and the mixture was stirred for 1 h at room temperature. The inorganic by-product (0.10 mol of potassium chloride) precipitated as a white solid and was carefully separated from solution by filtration. Then, a mixture of N-(phosphonomethyl) glycine and 3,6-dichloro-2-methoxybenzoic acid (7.2:1 mass ratio of glyphosate:dicamba) was poured into the flask to neutralize the poly(ammonium hydroxides) in the filtrate. Then, the solvent was evaporated using a rotary evaporator and the obtained product was dried under reduced pressure at 50° C. for 24 h. ¹H NMR (CDCl₃, 298K, 300 MHz) δ (ppm) 1.36 (s, 2H), 1.54 (s, 8H), 2.69 (s, 2H), 3.03 (s, 4H), 3.19 (s, 8H), 3.31 (s, 12H), 3.59 (s, 2H), 3.92 (s, 3H), 7.13 (m, 1H), 7.29 (m, 1H); ¹³C NMR (CDCl₃, 298K, 100 MHz) δ (ppm) 171.7, 171.1, 161.1, 153.4, 140.0, 134.6, 132.4, 129.7, 126.9, 71.6, 67.4, 62.4, 53.5, 47.3, 44.9, 40.1, 37.9, 28.2; ³¹P NMR (CDCl₃, 298K, 121 MHz) δ (ppm) 7.5 (s).

### Example 8-II—Poly(diallyldimethylammonium)N-(phosphonomethyl) glycinate 3,6-dichloro-2-methoxy-benzoate (p-[DADMA][Dic][Glyph] (1:4.8 Mass Ratio)

In a round-bottom flask, 0.10 mol of poly(diallyldimethylammonium chloride) was dissolved in 25 mL of anhydrous methanol followed by adding 0.10 mol of potassium hydroxide dissolved in 25 mL of anhydrous methanol and the mixture was stirred for 1 h at room temperature. The inorganic by-product (0.10 mol of potassium chloride) precipitated as a white solid and was carefully separated from solution by filtration. Then, a mixture of N-(phosphonomethyl) glycine and 3,6-dichloro-2-methoxybenzoic acid (4.8:1 mass ratio of glyphosate:dicamba) was poured into the flask to neutralize the poly(ammonium hydroxides) in the filtrate. Then, the solvent was evaporated using a rotary evaporator and the obtained product was dried under reduced pressure at 50° C. for 24 h. ¹H NMR (CDCl₃, 298K, 300 MHz) δ (ppm) 1.39 (s, 2H), 1.56 (s, 8H), 2.70 (s, 2H), 3.05 (s, 4H), 3.24 (s, 8H), 3.32 (s, 12H), 3.61 (s, 2H), 3.93 (s, 3H), 7.17 (m, 1H), 7.31 (m, 1H); ¹³C NMR (CDCl₃, 298K, 100 MHz) δ (ppm) 171.9, 171.0, 161.1, 153.3, 139.9, 134.6, 132.4, 129.7, 126.9, 71.6, 67.3, 62.4, 53.9, 46.8, 44.9, 40.1, 37.8, 28.1; ³¹P NMR (CDCl₃, 298K, 121 MHz) δ (ppm) 8.3 (s).

### Example 8-III—Poly(diallyldimethylammonium)N-(phosphonomethyl) glycinate (2,4-dichlorophenoxy)acetate (p-[DADMA][Glyph][2,4-D] (1.8:1 Mass Ratio))

In a round-bottom flask, 0.10 mol of poly(diallyldimethylammonium chloride) was dissolved in 25 mL of anhydrous methanol followed by adding 0.10 mol of potassium hydroxide dissolved in 25 mL of anhydrous methanol and the mixture was stirred for 1 h at room temperature. The inorganic by-product (0.10 mol of potassium chloride) precipitated as a white solid and was carefully separated from solution by filtration. Then, a mixture of N-(phosphonomethyl) glycine and 2,4-dichlorophenoxyaceetic acid (1.8:1 mass ratio of glyphosate:2,4-D) was poured into the flask to neutralize the poly(ammonium hydroxides) in the filtrate. Then, the solvent was evaporated using a rotary evaporator and the obtained product was dried under reduced pressure at 50° C. for 24 h. ¹H NMR (CDCl₃, 298K, 300 MHz) δ (ppm) 1.36 (s, 2H), 1.54 (s, 8H), 2.68 (s, 2H), 3.03 (s, 4H), 3.26 (s, 8H), 3.31 (s, 12H), 3.60 (s, 2H), 3.86 (s, 3H), 3.93 (s, 2H), 4.47 (s, 2H), 6.91 (s, 1H), 7.17 (m, 1H), 7.31 (m, 1H); ¹³C NMR (CDCl₃, 298K, 100 MHz) δ (ppm) 175.1, 172.1, 155.0, 130.7, 128.8, 126.5, 124.4, 116.0, 71.6, 69.6, 55.7, 54.8, 53.0, 47.1, 44.9, 40.1, 28.2; ³¹P NMR (CDCl₃, 298K, 121 MHz) δ (ppm) 7.5 (s).

### Example 8-IV—Poly(diallyldimethylammonium)N-(phosphonomethyl) glycinate (2,4-dichlorophenoxy)acetate (p-[DADMA][Glyph][2,4-D] (1.2:1 Mass Ratio))

In a round-bottom flask, 0.10 mol of poly(diallyldimethylammonium chloride) was dissolved in 25 mL of anhydrous methanol followed by adding 0.10 mol of potassium hydroxide dissolved in 25 mL of anhydrous methanol and the mixture was stirred for 1 h at room temperature. The inorganic by-product (0.10 mol of potassium chloride) precipitated as a white solid and was carefully separated from solution by filtration. Then, a mixture of N-(phosphonomethyl) glycine and 2,4-dichlorophenoxyaceetic acid (1.2:1 mass ratio of glyphosate:2,4-D) was poured into the flask to neutralize the poly(ammonium hydroxides) in the filtrate. Then, the solvent was evaporated using a rotary evaporator and the obtained product was dried under reduced pressure at 50° C. for 24 h. ¹H NMR (CDCl₃, 298K, 300 MHz) δ (ppm) 1.34 (s, 2H), 1.53 (s, 8H), 2.66 (s, 2H), 3.03 (s, 4H), 3.10 (s, 8H), 3.35 (s, 12H), 3.61 (s, 2H), 3.86 (s, 3H), 3.93 (s, 2H), 4.48 (s, 2H), 6.94 (s, 1H), 7.26 (m, 1H), 7.41 (m, 1H); ¹³C NMR (CDCl₃, 298K, 75 MHz) δ (ppm) 175.0, 172.0, 155.0, 130.7, 128.8, 126.5, 124.4, 116.0, 71.6, 69.7, 55.7, 54.8, 53.0, 47.0, 44.9, 40.1, 28.2; ³¹P NMR (CDCl₃, 298K, 121 MHz) δ (ppm) 8.4 (s).

### Example 8-V—Poly(bis(2-chloroethyl) ether-alt-1,3-bis[3-(dimethylamino)propyl]urea)N-(phosphonomethyl) glycinate 3,6-dichloro-2-methoxy-benzoate (p-[PEA][Dic][Glyph] (1:7.2 Mass Ratio))

In a round-bottom flask, 0.10 mol of poly(bis(2-chloroethyl) ether-alt-1,3-bis[3-(dimethylamino)propyl]urea) was dissolved in 25 mL of anhydrous methanol followed by adding 0.10 mol of potassium hydroxide dissolved in 25 mL of anhydrous methanol and the mixture was stirred for 1 h at room temperature. The inorganic by-product (0.10 mol of potassium chloride) precipitated as a white solid and was carefully separated from solution by filtration. Then, a mixture of N-(phosphonomethyl) glycine and 3,6-dichloro-2-methoxybenzoic acid (7.2:1 mass ratio of glyphosate:dicamba) was poured into the flask to neutralize the poly(ammonium hydroxides) in the filtrate. Then, the solvent was evaporated using a rotary evaporator and the obtained product was dried under reduced pressure at 50° C. for 24 h. ¹H NMR (CDCl₃, 298K, 300 MHz) δ (ppm) 2.00 (s, 5H), 2.81 (s, 2H), 3.20 (s, 12H), 3.48 (s, 6H), 3.69 (s, 8H), 3.93 (s, 4H), 4.01 (s, 3H), 7.02 (s, 2H), 7.19 (m, 1H), 7.25 (m, 1H); ¹³C NMR (CDCl₃, 298K, 75 MHz) δ (ppm) 171.7, 171.6, 171.1, 161.1, 153.1, 139.6, 129.9, 129.0, 127.3, 126.9, 65.7, 64.8, 64.6, 62.4, 52.4, 52.3, 52.1, 46.0, 43.4, 37.9, 24.7; ³¹P NMR (CDCl₃, 298K, 121 MHz) δ (ppm) 7.9 (s).

### Example 8-VI—Poly(bis(2-chloroethyl) ether-alt-1,3-bis[3-(dimethylamino)propyl]urea)N-(phosphonomethyl) glycinate 3,6-dichloro-2-methoxy-benzoate (p-[PEA][Dic][Glyph] (1:4.8 Mass Ratio))

In a round-bottom flask, 0.10 mol of poly(bis(2-chloroethyl) ether-alt-1,3-bis[3-(dimethylamino)propyl]urea) was dissolved in 25 mL of anhydrous methanol followed by adding 0.10 mol of potassium hydroxide dissolved in 25 mL of anhydrous methanol and the mixture was stirred for 1 h at room temperature. The inorganic by-product (0.10 mol of potassium chloride) precipitated as a white solid and was carefully separated from solution by filtration. Then, a mixture of N-(phosphonomethyl) glycine and 3,6-dichloro-2-methoxybenzoic acid (4.8:1 mass ratio of glyphosate:dicamba) was poured into the flask to neutralize the poly(ammonium hydroxides) in the filtrate. Then, the solvent was evaporated using a rotary evaporator and the obtained product was dried under reduced pressure at 50° C. for 24 h. ¹H NMR (CDCl₃, 298K, 300 MHz) δ (ppm) 2.00 (s, 5H), 2.87 (s, 2H), 3.19 (s, 12H), 3.47 (s, 6H), 3.70 (s, 8H), 3.93 (s, 4H), 4.01 (s, 3H), 6.85 (s, 2H), 7.20 (m, 1H), 7.3 (m, 1H); ¹³C NMR (CDCl₃, 298K, 100 MHz) δ (ppm) 171.7, 171.6, 171.3, 161.2, 153.3, 139.4, 130.0, 129.1, 127.4, 127.3, 65.7, 64.8, 64.6, 62.4, 52.4, 52.3, 52.1, 45.2, 43.4, 38.0, 24.8; ³¹P NMR (CDCl₃, 298K, 121 MHz) δ (ppm) 13.1 (s).

### Example 8-VII—Poly(bis(2-chloroethyl) ether-alt-1,3-bis[3-(dimethylamino)propyl]urea)N-(phosphonomethyl) glycinate (2,4-dichlorophenoxy)acetate (p-[PEA][Glyph][2,4-D] (1.8:1 Mass Ratio))

In a round-bottom flask, 0.10 mol of poly(bis(2-chloroethyl) ether-alt-1,3-bis[3-(dimethylamino)propyl]urea) was dissolved in 25 mL of anhydrous methanol followed by adding 0.10 mol of potassium hydroxide dissolved in 25 mL of anhydrous methanol and the mixture was stirred for 1 h at room temperature. The inorganic by-product (0.10 mol of potassium chloride) precipitated as a white solid and was carefully separated from solution by filtration. Then, a mixture of N-(phosphonomethyl) glycine and 2,4-dichlorophenoxy)acetic acid (1.8:1 mass ratio of glyphosate:2,4-D) was poured into the flask to neutralize the poly(ammonium hydroxides) in the filtrate. Then, the solvent was evaporated using a rotary evaporator and the obtained product was dried under reduced pressure at 50° C. for 24 h. ¹H NMR (CDCl₃, 298K, 300 MHz) δ (ppm) 1.99 (s, 5H), 2.81 (s, 2H), 3.10 (s, 12H), 3.46 (s, 6H), 3.66 (s, 8H), 3.99 (s, 4H), 4.55 (s, 2H), 6.91 (s, 1H), 6.95 (s, 2H), 7.24 (m, 1H), 7.26 (m, 1H), 7.41 (m, 1H); ¹³C NMR (CDCl₃, 298K, 75 MHz) δ (ppm) 175.2, 171.6, 161.2, 154.8, 130.7, 128.8, 126.4, 115.9, 69.6, 65.5, 64.7, 64.6, 52.3, 52.4, 47.6, 45.8, 43.1, 37.9, 24.9; ³¹P NMR (CDCl₃, 298K, 121 MHz) δ (ppm) 7.8 (s).

### Example 8-VIII—Poly(bis(2-chloroethyl) ether-alt-1,3-bis[3-(dimethylamino)propyl]urea)N-(phosphonomethyl) glycinate (2,4-dichlorophenoxy)acetate (p-[PEA][Glyph][2,4-D] (1.2:1 Mass Ratio))

In a round-bottom flask, 0.10 mol of poly(bis(2-chloroethyl) ether-alt-1,3-bis[3-(dimethylamino)propyl]urea) was dissolved in 25 mL of anhydrous methanol followed by adding 0.10 mol of potassium hydroxide dissolved in 25 mL of anhydrous methanol and the mixture was stirred for 1 h at room temperature. The inorganic by-product (0.10 mol of potassium chloride) precipitated as a white solid and was carefully separated from solution by filtration. Then, a mixture of N-(phosphonomethyl) glycine and 2,4-dichlorophenoxy)acetic acid (1.2:1 mass ratio of glyphosate:2,4-D) was poured into the flask to neutralize the poly(ammonium hydroxides) in the filtrate. Then, the solvent was evaporated using a rotary evaporator and the obtained product was dried under reduced pressure at 50° C. for 24 h. ¹H NMR (CDCl₃, 298K, 300 MHz) δ (ppm) 1.98 (s, 5H), 2.81 (s, 2H), 3.18 (s, 12H), 3.46 (s, 6H), 3.66 (s, 8H), 3.99 (s, 4H), 4.50 (s, 2H), 6.92 (s, 1H), 6.95 (s, 2H), 7.23 (m, 1H), 7.26 (m, 1H), 7.41 (m, 1H); ¹³C NMR (CDCl₃, 298K, 75 MHz) δ (ppm) 175.2, 171.6, 161.1, 154.8, 130.6, 128.8, 126.4, 115.9, 69.5, 65.7, 64.7, 64.6, 52.3, 52.2, 47.6, 45.8, 43.3, 37.9, 24.8; ³¹P NMR (CDCl₃, 298K, 121 MHz) δ (ppm) 7.9 (s).

The thermal properties of the polymer DSILs for Example 7 and 8 are shown in Table 3.

TABLE 3
Thermal properties of polymer DSILs

| | T_{g}^{a} | | | | |
|---|---|---|---|---|---|
| IL | (° C.) | T_{cryst}^{b} (° C.) | Tₘ^{c} (° C.) | T_{onset5%}^{d} (° C.) | Tₒₙₛₑₜ^{e} (° C.) |
| 7 | 39 | — | — | 116 | 416 |
| 8-I | 48 | — | — | 130 | 420 |
| 8-II | — | — | — | 118 | 422 |
| 8-III | 36 | — | — | 125 | 352 |
| 8-IV | 19 | — | — | 140 | 328 |
| 8-V | 21 | — | — | 172 | 300 |
| 8-VI | 19 | — | — | 150 | 310 |
| 8-VII | −5 | — | — | 145 | 289 |
| 8-VIII | 24 | — | — | 150 | 288 |

^{a}glass transition temperature,
^{b}temperature of crystallization,
^{c}melting point,
^{d}decomposition temperature of 5% sample,
^{e}decomposition temperature of 50% sample

### Example 9: Green House Studies of Polymeric Herbicidal Ionic Liquids

Common lambsquarters (Chenopodium album L.), cornflower (Centaurea cyanus L.) and winter wheat (Triticum aestivum L.) plants were grown in 0.5 L plastic pots containing commercial peat-based potting material. The plants were thinned to four per pot within 14 days after emergence and watered as needed. Greenhouse temperature was 20±2° C., humidity was 60% and 16/8 day/night hours. The applications were made using a spray chamber with a TeeJet 1102 flat-fan nozzle delivering 200 L ha⁻¹ of spray solution at 0.2 MPa operating pressure, when plants were at six-leaf growth stage. The sprayer was moving above the plants at a constant speed of 3.1 m/s. The distance between nozzle and target plants was 40 cm. The plants were treated once with water solution of tested compounds. The plots were arranged in a completely randomized setup with four replications. Fresh weight of plants was determined three weeks after treatment (WAT). Data were expressed as percent fresh weight reduction compared with control (no sprayed plants) (Table 4).

TABLE 4
The influence of different forms of glyphosate on fresh weight
reduction of common lambsquarters (Chenopodium album)

| IL | Treatment^{a} | Fresh weight reduction (%) |
|---|---|---|
| 7 | p-[DADMA][Glyph] | 52 |
| 8-I | p-[DADMA][Dic]₁[Glyph]_{7.2} | 15 |
| 8-II | p-[DADMA][Dic]₁[Glyph]_{4.8} | 14 |
| 8-III | p-[DADMA][Glyph]_{1.8}[2,4-D]₁ | 65 |
| 8-IV | p-[DADMA][Glyph]_{1.2}[2,4-D]₁ | 67 |
| 8-V | p-[PEA][Dic]₁[Glyph]_{7.2} | 51 |
| 8-VI | p-[PEA][Dic]₁[Glyph]_{4.8} | 49 |
| 8-VII | p-[PEA][Glyph]_{1.8}[2,4-D]₁ | 72 |
| 8-VIII | p-[PEA][Glyph]_{1.2}[2,4-D]₁ | 76 |
| | ROUNDUP 360 SL ™ | 31 |

^{a}all treatments at rate of 180 g ha⁻¹ of glyphosate

Field Experiments

The field trials were conducted in 2011 and 2012 at Experimental Station in Winna Gora (western part of Poland) on stubble, which was strongly infested by couchgrass (Elymusrepens (L.) Gould). All treatments were applied at the stage of the end of tillering of couchgrass (BBCH 30) using knapsack sprayer with XR 11003 flat-fan nozzles delivering 200 L ha⁻¹ of spray solution at 0.3 MPa of an operating pressure. Weed control was evaluated visually 4 weeks after herbicide applications using a scale of 0 (no control) to 100% (complete weed destruction).

Statistical Analyses

The data were subjected to ANOVA. Treatment means were separated using Fischer's Protected LSD test at the 5% probability level. All calculations were performed using Agriculture Research Manager (ARM) software.

The tests carried out in greenhouse showed that the efficacy of new forms of depended on the plant species as well as cation used in the synthesis of ionic liquid.

The interesting results obtained in greenhouse screening tests with different ionic liquids containing glyphosate led to the synthesis of new ionic liquids using other cations including polymer structures. These are useful and many of the synthesized compounds gave better results in biomass reduction compared with the standard formulation of glyphosate. Moreover, the polymer as cation gives the possibility to add other herbicidal anion in the composition. As shown in Table 1, many of these compounds were very active in weed control.

1.-29. (canceled)

30. A composition, comprising: at least one kind of polymeric cation at least two different kinds of anions, wherein two of the anions are chosen from 3,6-dichloro-2-methoxybenzoate, 2,4-dichlorophenoxyacetate, or 2-((phosphonomethyl)amino)acetate, and wherein the composition is a salt of the cation and anions with a melting point at or below about 150° C.

31. The composition of claim 30, wherein the at least one herbicidal anion is selected from the group consisting of 3,6-dichloro-2-methoxybenzoate, 2,4-dichlorophenoxyacetate, or 2-((phosphonomethyl)amino)acetate.

32. The composition of claim 30, wherein the polymeric cation comprises a monomer with at least one positive charge.

33. The composition of claim 30, wherein the monomer comprises a positively charged functional group selected from the group consisting of substituted or unsubstituted ammonium cation, substituted or unsubstituted phosphonium cation, substituted or substituted or unsubstituted pyridinium cation, a substituted or unsubstituted imidazolium cation, a substituted or unsubstituted morpholinium, a substituted or unsubstituted pyrrolidinium cation, a substituted or unsubstituted quinolinium cation, a substituted or unsubstituted isoquinolinium cation, or a substituted or unsubstituted mospholinium cation.

34. The composition of claim 30, wherein the polymeric cation is either Poly(bis(2-chloroethyl) ether-alt-1,3-bis[3-(dimethylamino)propyl]urea) or Poly(diallyldimethylammonium).

35. The composition of claim 30, wherein the polymeric cation has a molecular weight from 100 g/mol to 1,000,000 g/mol.

36. The composition of claim 30, wherein the polymeric cation has a polydispersity index from 1 to 10.

37. The composition of claim 30, wherein the composition is an ionic liquid and is liquid at a temperature at or below about 125° C.

38. (canceled)

39. (canceled)

40. (canceled)

41. (canceled)

42. The composition of claim 30, wherein the composition is an ionic liquid and is liquid at a temperature from about −30° C. to about 150° C.

43. (canceled)

44. The composition of claim 30, wherein the composition comprises a mass ratio of the two anions between 1 and 7.2.

45. The composition of claim 30, wherein the composition comprises a mass ratio of the two anions selected from the group consisting of 1, 1.2, 1.8, 4.8, or 7.2.

46. The composition of claim 30, further comprising a preservative, dye, colorant, thickener, surfactant, a viscosity modifier, or a mixture thereof at less than about 10 wt % of the total ionic liquid composition.

47. The composition of claim 30, further comprising an herbicidal active, a fungicidal active, a pesticidal active, or a plant food additive.

48. The composition of claim 30, further comprising a solvent or a mixture of solvents.

49. A delivery device comprising the composition of claim 30.
